(19) United States
(12) Patent Application Publication
(10) Pub. No.: US 2014/0142868 A1
(43) Pub. Date: May 22, 2014

(54) APPARATUS AND METHOD FOR INSPECTING TRACK IN RAILROAD

(71) Applicant: Andre C. Bidaud, Burnaby (CA)

(72) Inventor: Andre C. Bidaud, Burnaby (CA)

(73) Assignee: Andian Technologies Ltd., Burnaby (CA)

(21) Appl. No.: 13/777,705

(22) Filed: Feb. 26, 2013

Related U.S. Application Data
(60) Provisional application No. 61/727,742, filed on Nov. 18, 2012.

(51) Int. Cl. G01N 21/88

(52) U.S. Cl. CPC G01N 21/8803
USPC 702/40; 702/34

(57) ABSTRACT

A track inspection vehicle includes a track inspection platform with a propulsion system and a vehicle control system, at least one track inspection device, and a track inspection controller. The track inspection platform is to be positioned on a railroad. The propulsion system and vehicle control system selectively and adjustably operate and control the track inspection platform to traverse the railroad in a self-propelled manner. Each track inspection device produces electronic inspection data relating to a condition of the railroad in conjunction with operation of the track inspection platform to perform a railroad inspection task. The track inspection controller controls one or more track inspection device to selectively or continuously produce the corresponding electronic inspection data in conjunction with performance of the railroad inspection task. The track inspection vehicle may also include a remote control unit. Various methods for inspecting track in a railroad are also provided.

This application is based on and claims priority to U.S. Provisional Application No. 61/727,742, filed Nov. 18, 2012, which is incorporated herein by reference in its entirety.

### BACKGROUND

This disclosure relates to the inspection of railroad tracks for anomalies, and more particularly, to an automated or semi-automated, or remotely-operated track inspection vehicle. Various methods for inspecting the track, analyzing the geometry of the track, detecting defects, and providing alerts are described using the track inspection vehicle. Various embodiments of the track inspection vehicle and methods described herein may be used in conjunction with inspecting track in a railroad. However, the vehicle and methods described herein may be used for other purposes, such as periodic inspection tasks, post-installation inspection tasks, pre- and post-maintenance inspection tasks, and various scouting tasks.

The government authorities of most countries, by law, require periodic inspection of railways to ensure the safety of track structures and compliance with specific government, industry, or self-imposed rules and regulations. Inspections may be made on foot or by riding over the track in a vehicle at a speed that allows the person making the inspection to visually inspect the track structure for compliance with the government, industry, or self-imposed rules and regulations. For example, see TC E-54 Rules Respecting Track Safety, Railway Association of Canada, Nov. 25, 2011, 43 pages, for rules prescribing safety requirements for federally regulated standard gauge railway track in Canada. TC E-54 is commonly cited as the Track Safety Rules (TSR) and is incorporated herein by reference in its entirety. Mechanical, electrical and other track inspection devices may be used to supplement visual inspection. If a vehicle is used for track inspection, whether visual- or instrument-assisted, the speed of the vehicle may not be more than what is required to sufficiently accomplish the task of track inspection.

The frequency of such inspection varies with the class of the track. Each track is classified depending on, the type of use to which the track is subjected, i.e., freight, hazardous freight, passenger, etc.; the speed for which the track is rated; the number and weight of the cars typically travelling over the track; etc. The most rigorous inspection schedule is twice weekly with at least a one calendar day interval between inspections. Because a number of different rail usages trigger the most rigorous inspection schedule, most of the main line railroad in the world is required to comply with twice weekly visual inspections.

Visual inspections of tracks are required, in addition to other types of required inspections, such as the biannual inspection of tracks with ultrasonic and magnetic testers for internal defects. Currently, visual inspection of track is accomplished in one of two methods. In the first method, an individual inspector walks a length of track, viewing the track for anomalies. Upon detecting an anomaly, the inspector notes the type of anomaly and an approximate location of the anomaly, and either takes remedial action to correct the defect or orders an appropriate remedial action. Typically, a walking inspector covers five miles of track each day, at a rate of approximately 1.5 miles per hour. Because the government regulators (e.g., Federal Railroad Administration (FRA) in the United States) typically require the track to be inspected twice per week, not on consecutive days, a standard inspection schedule for a walking inspector involves covering a five-mile segment of track on Monday, covering a second five-mile segment of track on Tuesday, repeating the first five-mile segment on Wednesday, repeating the second five-mile segment on Thursday, with Friday scheduled as a free day, enabling the inspector to inspect track that was missed during the week, for whatever reason, or to complete whatever paperwork is required. Thus, the walking inspector covers ten miles of track per week.

In the second method, a vehicle is used to travel a length of track, with one or more inspectors viewing the track through a window. The vehicle is generally a truck adapted to ride on rails, more commonly called a hi-rail truck. As in the first method, upon detection of an anomaly, the inspector notes the type of anomaly, an approximate location of the anomaly, and either takes remedial action or recommends an appropriate remedial action. An inspection vehicle typically travels at speeds of approximately 10-20 miles per hour, and thus covers approximately 50-100 miles of track per day. Inspection by vehicle follows an inspection schedule similar to that of a walking inspector, covering one segment of track on Monday, a second segment on Tuesday, repeating the two segments on Wednesday and Thursday, respectively.

In general, the vast majority of visual inspections are performed using a hi-rail truck. Many hi-rail trucks are now equipped with track geometry measuring system (TGMS) which measure a number of geometrical components of the railroad track, such as the distance between the two rails (i.e., the track gage), the relative levelness of the rails to each other, the relative straightness of the two rails with respect to vertical and horizontal planes, and the shape of the curves of the track. Modern TGMS-equipped vehicles utilize an inertial measurement system, i.e., the system sets up an inertial reference frame to which the rail is compared. A measurement of track is taken approximately every foot, and differences exceeding a predetermined measurement are flagged, those differences affecting the safe and comfortable operation of the train over the track.

Since each track is classified depending on a plurality of parameters such as the type of use to which the track is subjected, i.e., freight, hazardous freight, passenger, the number and weight of the cars typically travelling over the track, and the speed for which the track is rated, all differences exceeding a predetermined measurement, are specific to a particular section of a particular track. Therefore, to properly assess any track condition, it is imperative to have precise location and precise measurements at those locations.

All railway operators would like to be able to operate trains at the maximum possible, safe speed. The maximum speed of the tracks is defined by a plurality of physical parameters. In the determinations of maximum safe speed conditions, such as the curvature of the rail track, the superelevation of one rail with respect to the other rail, and the lateral distance between the tracks (gauge of the track), are among some of the most important.

With reference to FIG. 6, a curved section of railroad track includes four basic components. Tangent track components are the “straight” portions of track. Generally speaking, tangent track does not have one rail higher than the other. An entry spiral component is associated with entry into a curve. This is the transition from tangent track (radius=infinity) to the body of the curve (radius=finite & constant). A body of the curve component is the curvature of the track whereby the radius of the curve is constant. An exit spiral component is associated with exiting out of the curve. This is the transition from curvature (radius=constant) back to tangent (radius=infinity).

The relationship of all measured and calculated parameters, and the safe operating limits, are dependent on which component of the four basic components you are on at the time. Therefore, any correct application of any government, industry, or self-imposed rules and regulations is dependent on exact knowledge of the track component in which you are located.

Depending on a plurality of parameters and geometrical relationships, as described above, the government authorities of most countries have established maximum track speed parameters. The rules governing maximum track speeds are included in track safety rules issued by the regulatory authority.

Unfortunately, in many areas where there is a high traffic incidence, it is not practical or feasible to tie up the track with a hi-rail or rail-bound track inspection vehicle. Furthermore, in areas of high traffic incidence, there are often portions of track that may require more frequent inspections than that mandated by law. Hence, walking inspections are required in such areas. Over the years, many manual or semi-automated tools have been developed to facilitate the walking inspection process. The usual requirement of these track inspection tools is that they are very quickly assembled on track, measurements taken, and then very quickly disassembled and removed from the track. Attempts have been made to automate or assist one or more of the inspections required by the governing authorities. However, no one automated or assisted “portable” device or method addresses all the data requirements for inspection as set forth by law.

No one manual track inspection device currently collects all the required data to apply the applicable government, industry, or self-imposed rules and regulations. Different types track inspection devices have to be deployed in order to gather the required information. Furthermore, because manual track inspection devices have to be quickly assembled on the track from many pieces, the validity of their respective calibrations is often suspect, leading to inaccurate and wrong applications of the government, industry, or self-imposed rules and regulations.

For these and other reasons, there is a need to improve existing techniques for inspection of railroads and measurement, calculation, and recording of geometric parameters of railway tracks.

### SUMMARY

In one aspect, an apparatus for inspecting track in a railroad is provided. In one embodiment, the apparatus includes: a track inspection platform configured to be positioned on a railroad formed by at least two tracks, the track inspection platform including a propulsion system and a vehicle control system. The propulsion system and vehicle control system are configured to selectively and adjustably operate and control the track inspection platform to traverse the railroad in a self-propelled manner. The apparatus also includes at least one track inspection device, each track inspection device disposed on the track inspection platform and configured to produce electronic inspection data relating to at least one condition of the railroad in conjunction with operation of the track inspection platform to perform a railroad inspection task, and a track inspection controller disposed on the track inspection platform and in operative communication with the vehicle control system and the at least one track inspection device. The track inspection controller is configured to control one or more track inspection device to selectively or continuously produce the corresponding electronic inspection data in conjunction with performance of the railroad inspection task.

In another aspect, an apparatus for inspecting track in a railroad is provided. In one embodiment, the apparatus includes: a remote control unit, and a track inspection vehicle in operative communication with the remote control unit. The track inspection vehicle includes: a track inspection platform configured to be positioned on a railroad formed by at least two tracks, the track inspection platform including a propulsion system and a vehicle control system. The propulsion system and vehicle control system are configured to selectively and adjustably operate and control the track inspection platform to traverse the railroad in a self-propelled manner. The track inspection platform also includes at least one track inspection device, each track inspection device disposed on the track inspection platform and configured to produce electronic inspection data relating to at least one condition of the railroad in conjunction with operation of the track inspection platform to perform a railroad inspection task, a track inspection controller disposed on the track inspection platform and in operative communication with the vehicle control system and the at least one track inspection device. The track inspection controller is configured to control one or more track inspection device to selectively or continuously produce the corresponding electronic inspection data in conjunction with performance of the railroad inspection task. The track inspection platform also includes a communication interface disposed on the track inspection platform in operative communication with at least one of the vehicle control system and the track inspection controller. The communication interface is configured to permit communication with the remote control unit. The remote control unit is configured to operate and control the track inspection vehicle for at least a portion of the railroad inspection task based at least in part on control signals exchanged with the track inspection vehicle via the vehicle communication interface. At least one of the vehicle control system and the track inspection controller are configured to operate in response to the control signals exchanged with the remote control unit for at least a portion of the railroad inspection task.

In yet another aspect, a method for inspecting track in a railroad is provided. In one embodiment, the method includes: positioning a track inspection platform on a railroad formed by at least two tracks, selectively and adjustably operating and controlling the track inspection platform using a propulsion system and a vehicle control system to traverse the railroad in a self-propelled manner, producing electronic inspection data via at least one track inspection device, the electronic inspection data relating to at least one condition of the railroad in conjunction with operation of the track inspection platform to perform a railroad inspection task, and controlling one or more track inspection device via a track inspection controller to selectively or continuously produce the corresponding electronic inspection data in conjunction with performance of the railroad inspection task.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an exemplary embodiment of a track inspection system;

FIG. 2 is an isometric front view of an exemplary embodiment of a track inspection system;

FIG. 3 is an isometric rear view of an exemplary embodiment of a track inspection system;

FIG. 4 is a side view of an exemplary embodiment of a track inspection vehicle;

FIG. 5 is a top view of an exemplary embodiment of a track inspection vehicle;

FIG. 6 is a geometric diagram representing components of an exemplary curve of a railroad track;

FIG. 7 is a block diagram of an exemplary embodiment of a track inspection vehicle;

FIG. 8 is a block diagram of another exemplary embodiment of a track inspection vehicle;

FIG. 9 is a flow chart of an exemplary embodiment of a process for inspecting track in a railroad;

FIG. 10, in conjunction with FIG. 9, is a flow chart of another exemplary embodiment of a process for inspecting track in a railroad;

FIG. 11, in conjunction with FIG. 9, is a flow chart of yet another exemplary embodiment of a process for inspecting track in a railroad;

FIG. 12, in conjunction with FIG. 9, is a flow chart of still another exemplary embodiment of a process for inspecting track in a railroad;

FIG. 13, in conjunction with FIG. 9, is a flow chart of still yet another exemplary embodiment of a process for inspecting track in a railroad;

FIG. 14, in conjunction with FIGS. 9 and 13, is a flow chart of another exemplary embodiment of a process for inspecting track in a railroad;

FIG. 15, in conjunction with FIGS. 9 and 13, is a flow chart of yet another exemplary embodiment of a process for inspecting track in a railroad;

FIG. 16, in conjunction with FIGS. 9, 13, and 15, is a flow chart of still another exemplary embodiment of a process for inspecting track in a railroad; and

FIG. 17, in conjunction with FIGS. 9, 13, and 15, is a flow chart of still yet another exemplary embodiment of a process for inspecting track in a railroad.

### DETAILED DESCRIPTION

Various embodiments of track analyzers and methods described herein relate to measuring and recording parameters of a railroad track. The embodiments described herein fill a gap between full-sized geometry cars that can cost in excess of two million dollars and small manual push-along measuring system. Each of these existing systems have fundamental flaws. For example, the small push along units do not collect the vertical or horizontal curvature information. Therefore, the push-along measuring system cannot apply correct track safety rules. The full-sized geometry cars are expensive to purchase, expensive to operate and maintain, and requires longer access time for deployment on the railroad.

In many areas, opportunities to inspect track are scarce due to large amounts of rail traffic. The track analyzers and methods described herein fill this need by being rapidly deployable and suitable for quickly measuring short to medium length segments of track. The track analyzers and methods described herein can implement current hi-rail-based track measurement technologies in a robotic cart. The current hi-rail systems make geometry measurements such as degree of curve, superelevation, gauge, surface and produces defect reports based on track classes and speeds according to the applicable government, industry, or self-imposed rules and regulations.

In one embodiment, the track analyzers and methods described herein incorporate a track geometry measurement system (TGMS) that is capable of autonomous (i.e., robotic) operation after being positioned on the railroad. The TGMS automatically determines subdivision and chainage, applies defect tolerances based on intended track speeds, begins and ends data collection periods, and creates logs and reports. For example, knowledge of location is required by government, industry, or self-imposed rules and regulations for defect reporting because the operating speed for trains at any location dictate the defect tolerances for that location. It is possible for track condition to constitute a defect for faster train speeds, but not for slower speeds.

The track analyzers and methods described herein implement various operating and control techniques and various types of track measurement techniques for a variety of operating scenarios. For example, the operating and control techniques include: i) an operator-controlled mode, ii) a lead/follow mode, iii) a semi-autonomous mode, and iv) an autonomous mode. Exemplary track measurement techniques include: i) a manual location mode and ii) an automatic location mode.

In the operator-controlled mode, the operator is in control of the vehicle and operates the vehicle very much like an radio-controlled (RC) car. In one embodiment, the operator keeps the vehicle within visual range and commands the vehicle based on visual perception of the vehicle and the environment in which it is operating. In the lead/follow mode, the vehicle is configured to keep a set distance ahead or behind another rail vehicle. An exemplary scenario for this mode includes running two TGMS vehicles, one ahead of and one behind a track maintenance vehicle to conduct a pre- and post-maintenance inspections.

In another exemplary scenario, the TGMS vehicle is sent ahead to scout and transmit results to a crew that conducts in-field verification. In the semi-autonomous mode, the operator instructs (e.g., programs) the TGMS vehicle to start at its current location and proceed autonomously to some further location. The TGMS vehicle may operate in this mode using knowledge of track mileage, dead reckoning, and/or GPS location information. Upon having covered the pre-described route, the vehicle can wait for human intervention or backup and return to its original starting location. In the autonomous mode, the TGMS vehicle (or fleet of TGMS vehicles) may be controlled by a system controller that schedules inspections and autonomously dispatches TGMS vehicles according a predefined inspection schedule, an ad hoc inspection, or an inspection to deal with special circumstances.

For track measurement techniques in the manual location mode, the operator is responsible for instructing the TGMS vehicle about its starting mileage, subdivision, and direction of travel. For track measurement techniques in the automatic location mode, the TGMS vehicle may have access to a database with GPS and mileages for locations in applicable subdivisions. The vehicle uses this database to determine subdivision, mileage and direction of travel.

For additional information on electronic track inspection and analysis of geometric parameters for track analyzers, see U.S. Pat. Nos. 6,347,265, 6,681,160, and 7,164,975 to Bidaud and assigned to Andian Technologies Ltd. The contents of these patents are fully incorporated herein by reference.

The '265 Andian patent discloses a track analyzer mounted on a vehicle traveling on a track. The track analyzer includes a vertical gyroscope for determining a grade and an elevation of the track. A rate gyroscope determines a curvature of the track. A speed determiner determines a speed of the vehicle relative to the track. A distance determiner determines a distance the vehicle has traveled along the track. A computing device, communicating with the vertical gyroscope, the rate gyroscope, the speed determiner, and the distance determiner, a) identifies a plurality of parameters as a function of the grade, elevation, and curvature of the track, b) determines in real-time if the parameters are within acceptable tolerances, and, c) if the parameters are not within the acceptable tolerances, generates corrective measures.

The '160 Andian patent discloses track and track/vehicle analyzers for determining geometric parameters of tracks, determining the relation of tracks to vehicles and trains, analyzing the parameters in real-time, and communicating corrective measures to various control mechanisms are provided. In one embodiment, the track analyzer includes a track detector and a computing device. In another embodiment, the track/vehicle analyzer includes a track detector, a vehicle detector, and a computing device. In other embodiments, the track/vehicle detector also includes a communications device for communicating with locomotive control computers in lead units, locomotive control computers in helper units, and a centralized control office. Additionally, a method for determining and communicating an optimized control strategy is provided. A method for dynamically modeling vehicle behavior, determining probabilities for derailment, and communicating recommended actions is also provided. The analyzers contribute to operational safety and overall efficiency, including fuel efficiency, vehicle wheel wear, and track wear, in railroad systems.

The '975 Andian patent discloses improvements to the track and track/vehicle analyzers of the '160 Andian patent that include further methods for determining and communicating optimized control strategies for locomotive control computers, truck lubrication systems, and truck steering mechanisms. The analyzers further contribute to operational safety and overall efficiency, including fuel efficiency, vehicle wheel wear, and track wear, in railroad systems.

The various embodiments of track inspection vehicles and methods disclosed herein can utilize any combination of operating and control techniques and track measurement techniques that are suitable for various operating scenarios. Multi-mode track analyzers may permit selection of some suitable combination of techniques. In other words, the operator may be given discretion to select a suitable operating and control technique and a suitable track measurement technique for a given operating scenario. Obviously, the automatic location mode is superior to manual location mode and considered an optimal method of operation for track measurement.

Wireless technologies may be used for communications between units, for syncing systems and for operation of systems in tandem. Syncing of multiple units allows for additional features such as: calculation of more complex measurements, repeatability testing and verification between units, data relaying for range extension, task-splitting between units, real-time pre- and post-maintenance inspection, and scouting missions. For example, Wi-Fi, cellular, and radio control links allow manual control and video streaming to varying degrees based on network performance.

Each network technology will include signal and connection-monitoring capabilities allowing actions to be taken in attempts to restore connectivity or return to base should contact be lost. Machine learning software and reference data of landscapes in various weather conditions are used to predict signal strength to take actions to maintain maximum connectivity, initiate power-saving measures and reduce time spent in wireless dead zones.

Accordingly, in one embodiment, an improved inspection vehicle provides for visual inspection of railroad tracks with a device that is easy to deploy on track, is inherently calibrated, and gathers all data required for compliance with applicable government, industry, or self-imposed rules and regulations. In another embodiment, an improved inspection vehicle and method of inspection reduces the high costs currently associated with visual inspection. In yet another embodiment, an improved inspection vehicle and method of inspection permits travel over railroad tracks, collecting a full range of geometry parameters. In a further embodiment, an improved inspection vehicle and method of inspection provides a redundant/backup means for ascertaining defects. In order to minimize weight and achieve portability, the track inspection vehicle may be constructed of modern materials using manufacturing techniques to reduce the weight of components and ensure suitable durability and suitable weather resistance for intended environments in which the track inspection vehicle may be used.

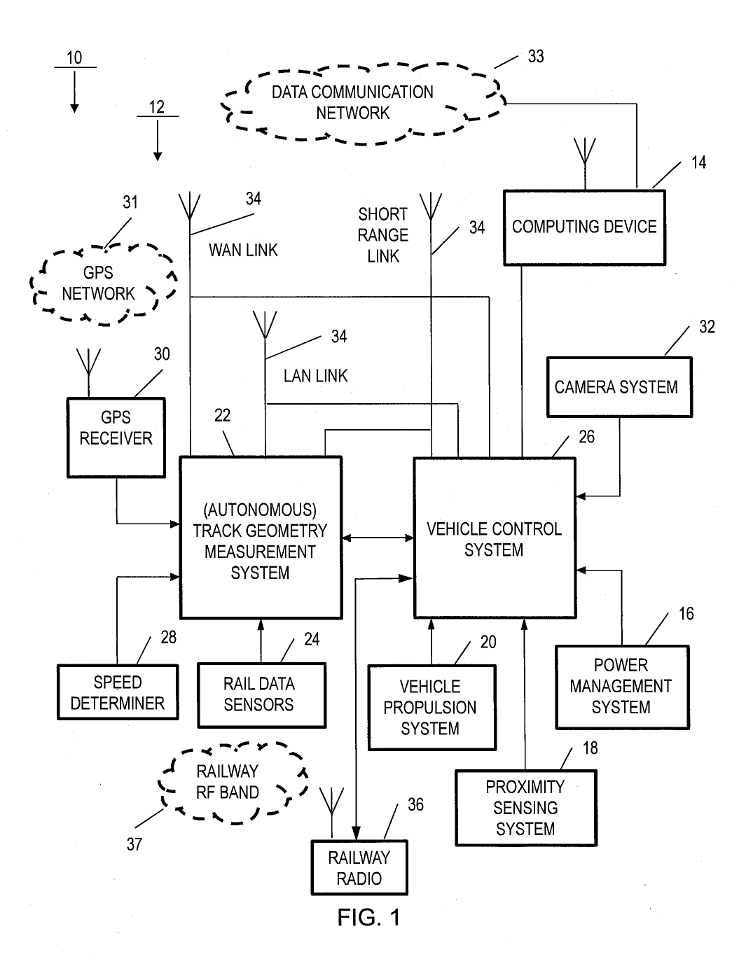

With reference to FIG. 1, an exemplary embodiment of the track inspection system 10 includes an exemplary embodiment of a track inspection vehicle 12 and a computing device 14. The exemplary embodiment of the track inspection vehicle 12 includes a power management system 16, a proximity sensing system 18, a vehicle propulsion system 20, a track geometry measurement system 22, rail data sensors 24, a vehicle control system 26, a speed determiner 28, a global positioning system (GPS) receiver 30, a camera system 32, one or more wireless transceiver(s) 34, and a two-way railway radio 36.

The power management system (PMS) 16 monitors available power and estimates maximum distance that can be traveled. These estimates are based on past vehicle performance. Warnings are given if there is insufficient power capacity to complete a specified task. There is an emergency backup power system that lets the vehicle 12 emit a homing signal in the event of a primary power failure.

The proximity sensing system (PSS) 18 monitors a plurality of sensors to determine if the vehicle 12 is in any danger of running into an unexpected foreign object on the track. If there is a determination that a dangerous condition exists, the vehicle PSS 18 will instruct the vehicle propulsion system 20 to bring the vehicle 12 to a controlled stop. The PSS 18 is also used to keep the vehicle 12 a set distance away from another vehicle when propulsion is set to lead/follow mode.

The vehicle propulsion system (VPS) 20 includes a vehicle propulsion controller. The VPS 20 controls maximum vehicle speed, can maintain constant vehicle speed through the use of a feedback control mechanism and a proportional-integral-derivative (PID) algorithm. The VPS 20 can also control maximum vehicle acceleration and de-acceleration to ensure there is no wheel slip. The VCS 26 can monitor a plurality of collision/obstruction avoidance sensors (e.g., proximity sensors) associated with the PSS 18 and, in conjunction with the VPS 20, can automatically bring the vehicle 12 to a controlled stop in order to prevent a collision or at least reduce damage caused by a collision.

The track geometry measurement system (TGMS) 22 includes an embedded system connected to a plurality of sensors to coordinate acquisition of rail parameters, mileage, and GPS coordinates. The TGMS 22 can accept, record, and process sensor values into track measurements representative of track conditions. The track conditions can be evaluated against applicable government, industry, or self-imposed rules and regulations and, depending on the mode of operation, reported to operating personnel in near real-time, periodically during the assigned task, or upon completion of the assigned task. In the autonomous mode of operation, the TGMS 22 can determine a probability that a defect exists based on corresponding track conditions. If the probability of the detected defect falls below a pre-determined confidence level, the TGMS 22 can instruct the vehicle 12 to back up and re-test the track section under suspicion. The TGMS 22 can also supply curvature and speed information to the VCS 26. This information allows the VCS 26 to instruct the VPS 20 as to the appropriate vehicle acceleration and speed to ensure good data collection with no wheel slip.

The rail data sensors (RDS) 24 include a plurality of sensors used to make physical track measurements upon which a plurality of track defect conditions are evaluated under applicable government rules and regulations, industry standards, or standards elected by the railroad operator. These measurements include but are not limited to: curvature, elevation, gauge, surface, rail profile, linear induction motor (LIM) height, rail corrugation, rail temperature, and rail flaw.

The vehicle control system (VCS) 26 includes an embedded system that accepts real-time user commands and executes a pre-programmed sequence of actions for vehicle control. The VCS 26 coordinates power management, direction, propulsion and braking of the vehicle 12. The VCS 26 may also accept instructions and commands from the TGMS 22 that either recommend or direct appropriate vehicle 12 and/or testing speeds for a particular section of track that it is currently testing. This can assist in minimizing wheel slippage in order to achieve accurate speeds and distance determinations. The VCS 26 may also be able to initiate a “distress call” upon determining a condition exists that requires outside assistance.

The speed determiner (SD) 28 measures rotation of the vehicle wheels to determine speed and distance travelled. The GPS receiver 30 received GPS data from satellites of a GPS network 31 and provides global geographical coordinates of the vehicle 12 to the TGMS 22. The GPS receiver 30 can be used to determine track mileage and subdivision. The GPS receiver 30 can also be used to communicate the location of the vehicle 12 in the event of a distress call or for other purposes.

The computing device (CD) 14 may include a laptop computer, a desktop computer, a tablet computer, a hand-held computer, a smart phone, a mobile phone, a satellite phone, a landline phone, a remote control, a programming device, or any suitable computer device in any suitable combination. The CD 14 and track inspection vehicle 12 are in operative communication via a short range wireless interface, an interconnecting cable, a wireless communication network, a wired communication network, or any suitable combination of wireless and wired communication networks 33. The CD 14 may be used for setup, configuration, and calibration of the vehicle 12. In certain embodiments, the CD 14 may act as an RC controller. The CD 14 may retrieve test data, view test data, and generate reports from the test data. The CD 14 may also be used to view images or video from the camera system 32 in real-time, near real-time, or on-demand.

The camera system (CS) 32 includes a plurality of cameras. One or more cameras may be aimed straight ahead to view track and the surrounding environment which the vehicle 12 is approaching. One or more cameras may be aimed toward the track over which the vehicle 12 is currently passing for tie, clip, and joint inspection. One or more cameras may be aimed backward to view track and the surrounding environment behind the vehicle 12. Any camera may be moveable to alter the direction of view and/or adjustable as to zoom and focus. Movement and adjustments to the camera may be predetermined, programmable via the CD 14, or remotely controlled via the CD 14. If multiple remotely controlled cameras are employed, the CD 14 may be able to select one or more cameras for simultaneous remote control.

The one or more wireless transceiver(s) 34 may include a short range wireless transceiver (e.g., a Bluetooth transceiver, a radio frequency (RF) transceiver, an infrared (IR) transceiver, an RF identity (RFID) transceiver), a wireless local area network (LAN) transceiver (e.g., a WiFi transceiver, a WLAN transceiver), a wireless wide area network (WAN) transceiver (e.g., a WiMAX transceiver, a mobile network transceiver, a satellite network transceiver), a multi-mode wireless transceiver, or any suitable wireless transceiver in any suitable combination. For example, a WiFi transceiver provides a WiFi link (WL) to the vehicle 12. The WiFi transceiver may include a wireless LAN hosted by a wireless router or access point on the vehicle 12. The short range wireless transceiver may be used for in-field interaction, starting and ending data collection, data transfer, and programming the vehicle 12 to perform a task. In another example, a multi-mode wireless transceiver may operate in higher and lower power modes. The higher power mode may be used over longer distances in conjunction with one or more types of WANs 33 accessible to the wireless transceiver 34. The lower power mode may be used to conserve power when higher power transmission is not required and in conjunction with one or more types of short range devices and LANs accessible to the wireless transceiver 34.

In another example of a wireless transceiver 34, a mobile network transceiver provides a cellular link (CL) to the vehicle 12. The mobile network transceiver may include a link to the Internet via the cellular network 33. This allows data to be automatically uploaded to and downloaded from a remote storage device (e.g., server, database, etc.). The CL also allows for online tracking of the vehicle in real-time or near real-time.

In yet another example of a wireless transceiver 34, a short range wireless transceiver may provide an RC link (RCL) to the vehicle 12 for a corresponding short range wireless transceiver on the CD 14. The RCL allows the vehicle 12 to be controlled remotely by human interaction with the CD 14 or by automated controls in the CD 14. Such types of remote control of the vehicle 12 is in real time.

The two-way railway radio 36 is configured with standard railway radio communication channels to allow voice communication with the railway radio network 37 from the vehicle 12. For example, the two-way railway radio 36 may include a very high frequency (VHF) radio commonly used in railway radio networks 37 or any suitable two-way radio that would permit voice communications with authorized and desired persons in conjunction with operation of the vehicle 12 and/or the railroad.

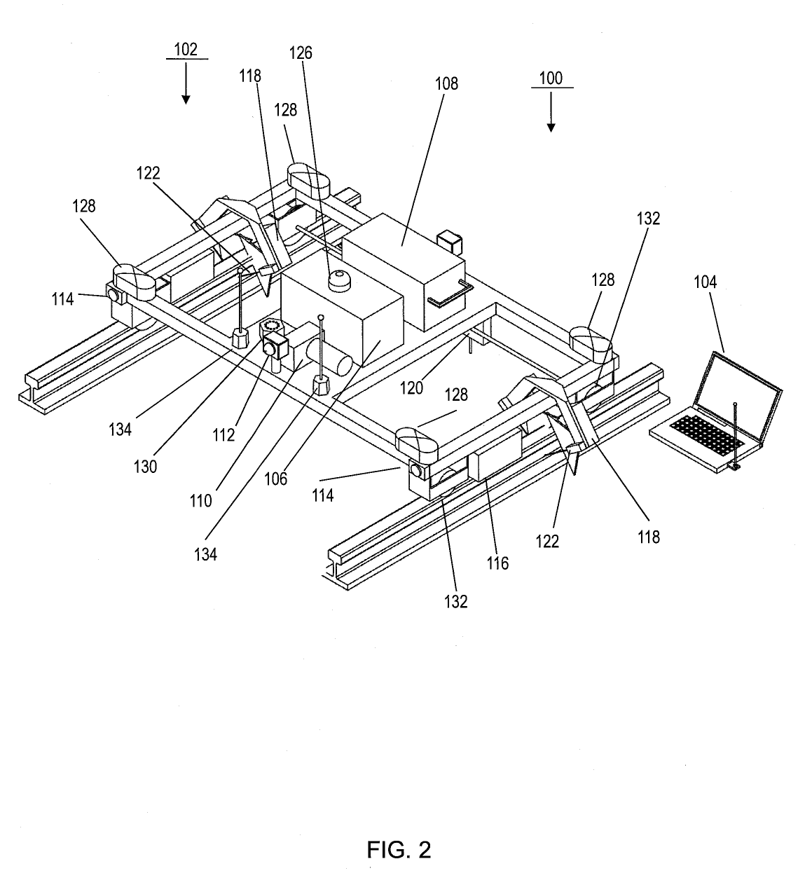

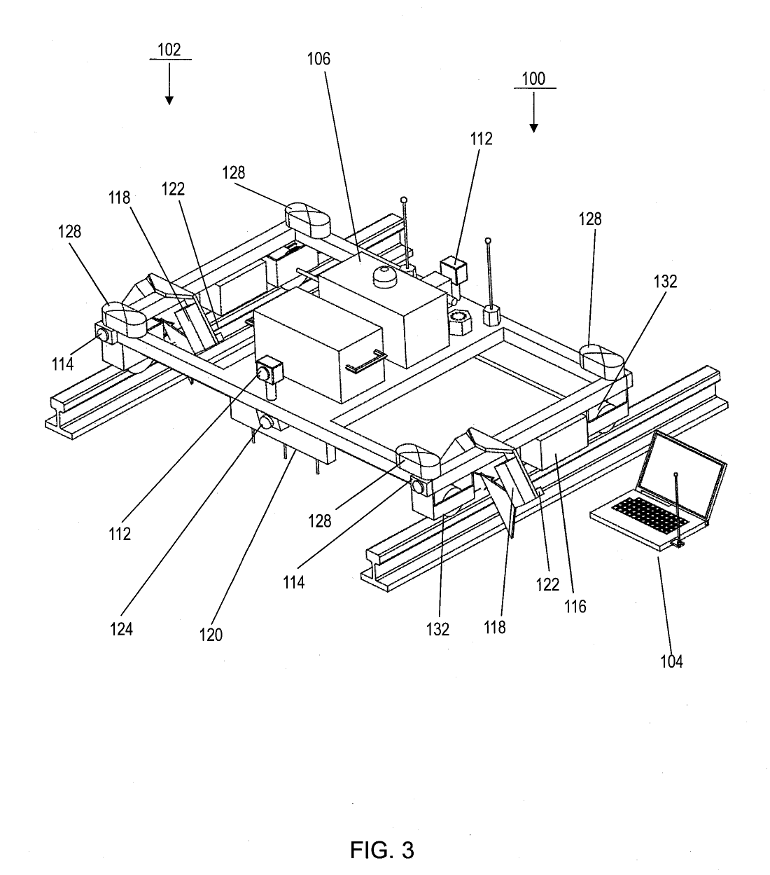

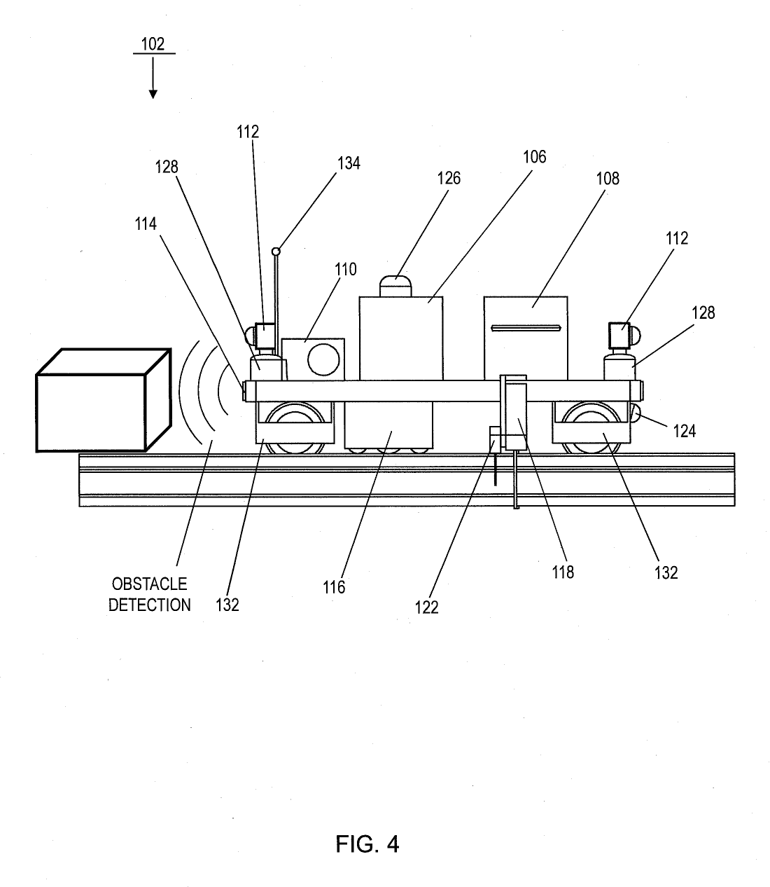

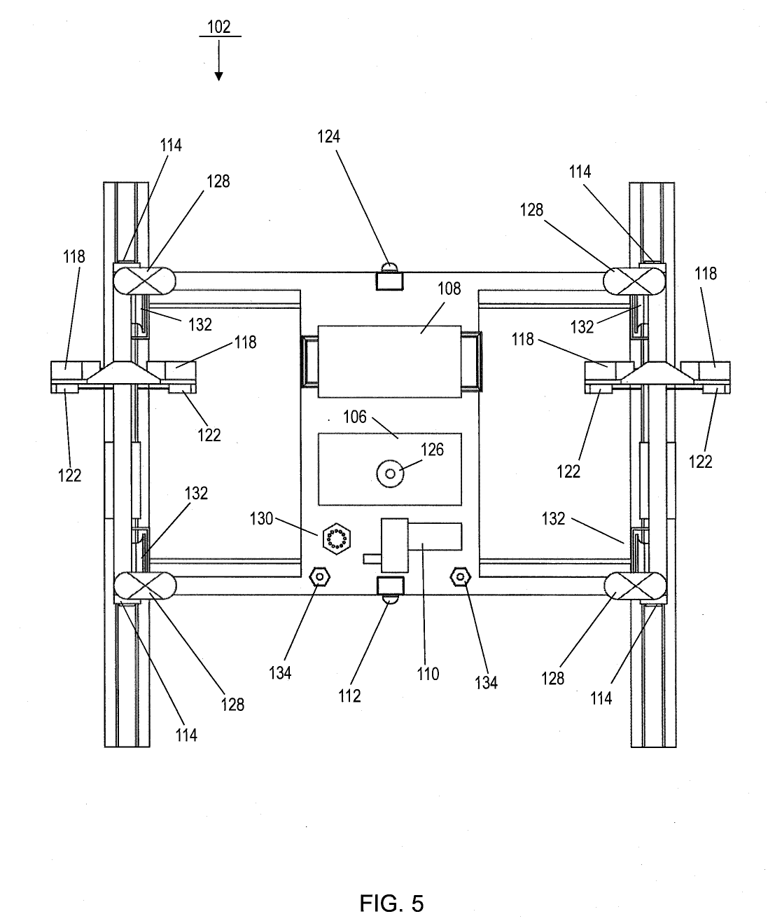

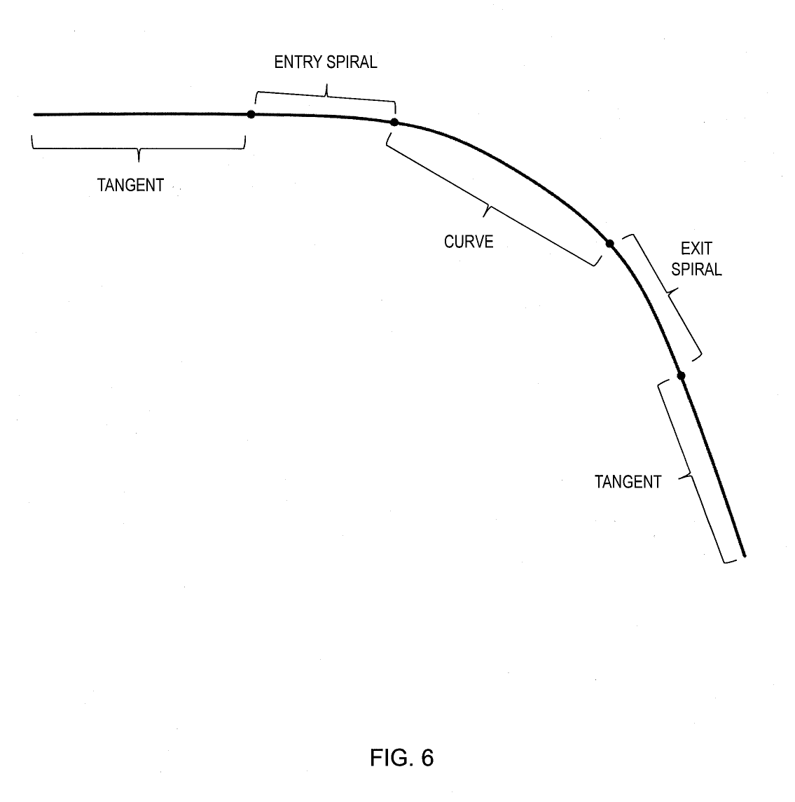

With reference to FIGS. 2-4, another exemplary embodiment of a track inspection system 100 includes a track inspection vehicle 102 and a computing device 104. An exemplary embodiment of the track inspection vehicle 102 includes an instrumentation box 106, a power supply 108, one or more vehicle drive motors 110, navigation cameras 112, proximity sensors 114, rail flaw detectors 116, laser profiling sensors 118, linear induction motor (LIM) reaction rail height sensors 120, temperature sensors 122, a downward-facing camera 124, a GPS receiver 126, beacon lights 128, a beeper 130, wheel assemblies 132, and antennae 134.

The instrumentation box 106 encloses the TGMS 22, VSC 26, PMS 16 components. The instrumentation box 106 also encloses inertial sensors and much of the communications equipment. The instrumentation box 106 may be hermetically sealed and temperature-controlled. In other embodiments, the instrumentation box 106 may not necessarily be airtight, but may be sufficiently weather resistant and sufficiently durable to protect its contents from damage and/or degradation due to environmental conditions.

The power supply 108 supplies power to the propulsion system 20, TGMS 22, vehicle control system 26, camera system 32, sensors, and other electrically-powered components of the vehicle 102. The power supply 108 may include one or more batteries, one or more fuel cells, one or more solar cells, one or more generators, a power control/regulation assembly, and any other suitable type of power source in any suitable combination. The generator may be powered by an internal combustion engine. In particular, the power supply 108 may be a hybrid combination of battery and generator components. The power supply 108 may be connected via quick coupling connector assemblies for easy assembly, removal, and change out.

The one or more vehicle drive motors 110 propel the vehicle 102 back and forth on the railroad between start and destination points in conjunction with performing an assigned task. Each motor is controlled by the VPS 20.

The navigation cameras 112 face forward and rearward depending on the direction of travel for the vehicle 102. For example, when the vehicle 102 is moving along the track in one direction a first navigation camera 112 is facing forward and a second navigation camera 112 is facing rearward. Conversely, when the vehicle is moving along the track in the opposite direction the first navigation camera 112 is facing rearward and the second navigation camera 112 is facing forward. The navigation cameras 112 may be remotely adjustable using the computing device 104 to control the direction of view, zoom, and/or focus. The navigation cameras 112 may output still frame images and/or video. The image/video information from the navigation cameras 112 may be processed by the camera system 32 so that the TGMS 22 and/or VCS 26 can use the information to detect potential hazardous conditions and/or as an input for controlling movement of the vehicle 102. The image/video information may also be provided to a local storage device for temporary archiving and to the computing device 104 and/or a remote storage device via the wireless transceiver(s) 34.

The proximity sensors 114 are positioned at the front and rear of the vehicle 102 for use by the VCS 26 to form a primary collision/obstruction avoidance system for the vehicle 102. The proximity sensors 114 may include, but are not limited to, ultrasonic sensors, pulsed radar sensors, RFID transceivers, infrared distance sensors, optical distance sensors, or any suitable ranging sensor. Data from the proximity sensors 114 is interpreted and acted upon by the VCS 26 and, in conjunction with avoiding a collision, the VPS 20 to bring the vehicle 12 to a controlled stop in order to prevent a collision or at least reduce damage caused by a collision. For example, if the proximity sensors 114 detect an obstacle ahead of the vehicle 102, proximity sensing and collision avoidance control mechanisms in the VCS 26 cause the VPS 20 to apply braking to bring the vehicle 102 to a controlled stop.

The rail flaw detectors 116 include instruments for detecting internal rail defects, such as voids, cracks, etc. The rail flaw detectors 116 may include commercially available detectors, commercial detectors customized for the vehicle 102, or third party add-on detectors.

The laser profiling sensors 118 measure horizontal and vertical profiles of the rails to detect conditions such as gauge, cant, vertical wear, rail head loss, etc. The laser profiling sensors 118 may include commercially available sensors, commercial sensors customized for the vehicle 102, or third party add-on sensors.

In certain railroads over which locomotive or other transport vehicles may be LIM powered, there may be a requirement to measure the height (i.e., vertical location) of the LIM reaction rail relative to the height of the running rails. The LIM reaction rail height sensors 120 can detect the height of the LIM reaction rail. The TGMS, in conjunction with the laser profiling sensors 118 and the LIM reaction rail height sensors 120, can determine the height of the LIM reaction rail in relation to the height of the running rails. The LIM reaction rail height sensors 120 may include commercially available sensors, commercial sensors customized for the vehicle 102, or third party add-on sensors. For example, the LIM reaction rail height sensors 120 may include an arrangement of laser sensors.

The temperature sensors 122 may include non-contact IR thermometers to measure the rail temperature which can be used to determine if the rail is at risk of cracking or having sun kinks (buckling).

The downward-facing camera 124 may be used to collect information on ties, clips and joints. The image/video information from the downward-facing camera 124 may be processed by the camera system 32 so that the TGMS 22 can use the information to detect potential hazardous conditions. The image/video information may also be provided to a local storage device for temporary archiving and to the computing device 104 and/or a remote storage device via the wireless transceiver(s) 34.

The GPS receiver 126 can provide the geographical coordinates of the vehicle to the TGMS 22 for referencing track geometry measurements, to the VCS 26 for monitoring progress and/or determining arrival at a desired destination, to the computing device 104 for real-time or near real-time tracking of the vehicle 102, to a local storage device for temporary archiving, and/or to a remote storage device. The GPS receiver 126 can be used to determine track mileage and subdivision. The GPS receiver 126 can also be used to communicate the location of the vehicle 12 in the event of a distress call or for other purposes.

The beacon lights 128 are configured to provide a visual alert identifying the vehicle 102, for example, to operators in trains, locomotives, and other vehicles traveling along the railroad as well as to pedestrians and persons in vehicles that may be attempting to cross the railroad. In many cases, beacon lights 128 are mandatory under applicable government, industry, or self-imposed rules and regulations for railroads.

The beeper 130 is configured to provide an audible warning of the presence of the vehicle 102. In many cases, the beeper 130 is mandatory under applicable government, industry, or self-imposed rules and regulations for railroads.

The wheel assemblies 132 may include a wheel and an encoder assembly or another type of sensor suitable for detecting speed and distance. The sensor can detect and follow movement of the wheel and provide a corresponding signal to the VCS 26. The VCS 26 can use the wheel sensor signal to determine speed, acceleration, and/or distance traveled for the vehicle 102. In certain embodiments, the distance traveled can be used in conjunction with a compass or other navigational sensors to determine and/or confirm location of the vehicle 102. At least two wheel assemblies, on opposite sides of the vehicle 102, are driven by the vehicle drive motor(s) 110. The driven wheel assemblies 132 may be connected to a single drive motor via a suitable drive train. Alternatively, each drive wheel assembly may be connected to its own drive motor via a suitable drive train. The drive trains may include pulleys, belts, gears, chains, and axles in any suitable combination. The wheel assembly, drive train, and/or chassis may include a mechanism to control when the rails are “shunted” (i.e., shorted to each other) in order to activate pedestrian/vehicle barriers and warnings at railroad crossings.

The antennae 134 enable wireless communications with other devices. For example a first antenna 134 may enable communications with the computing device 104, a second antenna 134 may enable communications with standard railway radios, and a third antenna 134 may enable reception of data from GPS satellites 31. The antennae 34 can provide wireless data interfaces for short range wireless communications, wireless LAN communications, wireless WAN communications, or multi-mode wireless communications. The antennae 34 can also provide a wireless voice interface for standard railway radio channels, wireless LAN communications, wireless WAN communications, or multi-mode wireless communications.

The computing device 104 may include a laptop computer, a desktop computer, a tablet computer, a hand-held computer, a smart phone, a mobile phone, a satellite phone, a landline phone, a remote control, a programming device, or any suitable computer device in any suitable combination. The computing device 104 and track inspection vehicle 102 are in operative communication via a short range wireless interface, an interconnecting cable, a wireless communication network, a wired communication network, or any suitable combination of wireless and wired communication networks. The computing device 104 may be used for setup, configuration, and calibration of the vehicle 102. In certain embodiments, the computing device 104 may act as an RC controller. The computing device 104 may retrieve test data, view test data, and generate reports from the test data. The computing device 104 may also be used to view images or video from the camera system 32 in real-time, near real-time, or on-demand.

In one embodiment, a method of inspecting railroad track includes using an unmanned, self-propelled vehicle, collecting data from a plurality of sensors, and controlling propulsion of the vehicle. The vehicle provides multiple modes for controlling propulsion and multiple modes of data collection. For example, the vehicle has a mode for controlling propulsion wherein the vehicle is remote controlled by its operator. The vehicle has another mode for controlling propulsion wherein the vehicle leads or follows another vehicle, such as a tamper or hi-rail, by a set distance. The vehicle has yet another mode for controlling propulsion wherein the vehicle executes a set of instructions that are pre-programmed by the operator on where to go for data collection and what to do when that is done. The set of instructions provides the option of travelling at different speeds in different segments of track as instructed either by manual control (operator control), or as instructed by the TGMS sub-system. The vehicle can be instructed to wait at a specified location to be picked up, or to return to its starting location.

The vehicle has still another mode for controlling propulsion wherein the vehicles actions are automatically coordinated according to what segments of track require inspection and what segments are available for inspection at any given time. The on-board TGMS may generate sets of instructions providing the option of travelling at different speeds in different segments of track.

The vehicle has a mode of data collection wherein the operator manually enters the subdivision, mileage, and direction of travel of the vehicle for the inspection. The vehicle has another mode of data collection wherein the vehicle accesses reference information about all applicable subdivisions to automatically determine the subdivision, mileage and direction of travel for the inspection.

In one embodiment, the vehicle accepts control commands remotely using a long-range wireless link. The wireless control method may be secure and may require authentication such that only the authorized operator can command the vehicle. The vehicle can transmit its data directly to computing devices in the vicinity over a local wireless network. The vehicle can accept configuration and calibration settings directly from computing devices in the vicinity over a local wireless network. The vehicle can automatically upload its real-time data and completed reports to a secure internet webpage over a cellular link.

The vehicle can include a VHF radio programmed with radio channels that are used by railways in its region. The vehicle can communicate over railway radio networks using synthesized or pre-recorded voice statements and voice recognition.

The vehicle is constructed in such a manner to make insertion onto the track and removal from the track in a short and timely manner. The vehicle is constructed and designed in such a manner that it can be installed/removed from the track structure by a single individual. The vehicle can be loaded onto a pickup or SUV for long-range road transport and battery charging.

The vehicle has a primary power system for propulsion, sensor power, and communications. The batteries can be easily inserted and removed and swapped for full ones if required. The vehicle may include a power monitoring system that estimates the possible travel distance based on available power, past power consumption, and the terrain that needs to be covered (up or down hills). Warnings may be given if the operator attempts to instruct the vehicle to make a journey from which it will not have the power to return. The vehicle may include an emergency backup power system that allows it to transmit a homing signal so it can be located in the event of a primary power failure or the detection of some condition that impedes its designated objectives. This power system may be solar since its power requirements are low.

The vehicle may include a proximity sensing system that detects when there is an obstacle or person in its path. In this event, the vehicle performs a controlled stop. If the vehicle is out of visual range of its operators at the time, it may transmit a message informing its operators of the situation. The stopping functionality can be overridden when the vehicle is under direct human supervision. The proximity sensing system can also be configured to have the vehicle lead or follow another track vehicle by a set distance. An example of this mode would be running two vehicles, one ahead of and one behind a tamper, to conduct a pre- and post-maintenance inspection.

The TGMS can provide curvature information to the vehicle control system (VCS), such that, the VCS can direct the proximity management system (PMS) to direct its sensors into the curve, where by increasing the usable range of the sensor assembly.

The vehicle may employ primary and emergency braking systems. The primary braking system may be equipped with antilock braking system (ABS) to prevent skidding, which would increase stopping distances and increase wheel wear. The primary braking system may incorporate a combination of friction, dynamic, and regenerative braking. The emergency braking system may be engaged in the event that the primary braking system fails to decrease the speed.

The braking system may instruct the vehicle not to stop in curves or on crossings unless it would be unsafe to do otherwise. Stopping in a curve is undesirable due to reduced visibility around curves. Stopping on a crossing is undesirable because the track inspection vehicle would obstruct the road.

The vehicle may include a PID controller to manage acceleration, deceleration and keeping constant speed. The controller would prevent or at least reduce wheel slip from occurring. The vehicle may use a GPS receiver to get the latitude and longitude coordinates of its location. These coordinates can be used to determine the vehicle's subdivision and mileage. The location coordinates may also be used in the event that the vehicle makes a distress call. The vehicle may include a speed determiner to measure speed and distance travelled. Knowledge of speed is required for inertial calculations. Knowledge of distance travelled is required for determining sample rates of sensors.

The vehicle may include downward facing front and back cameras for tie, clip and joint inspection. The camera images may be transmitted over the Wi-Fi and cellular links in real time. The vehicle may include outward facing front and back cameras for visual inspection. These cameras can be aimed remotely by the computing device. The camera images may be transmitted over the Wi-Fi and cellular links in real-time. The cameras can also act as a deterrent against theft and vandalism. The vehicle can drive in both the forward and reverse directions. The vehicle can also collect rail data in both the forward and reverse directions. The vehicle can be configured, using the computing device, as to whether or not it “shunts” between the two rails. This allows the operator to select whether or not the vehicle will activate railway signals.

When multiple vehicles are deployed, they can act as repeaters. The vehicle nearer to the operator can relay transmissions from the further one to the operator if the further vehicle is out of wireless range of the operator.

The vehicle may be equipped with an audible beeper and high-visibility beacon strobe lights for reasons of safety and compliance with railroad regulations.

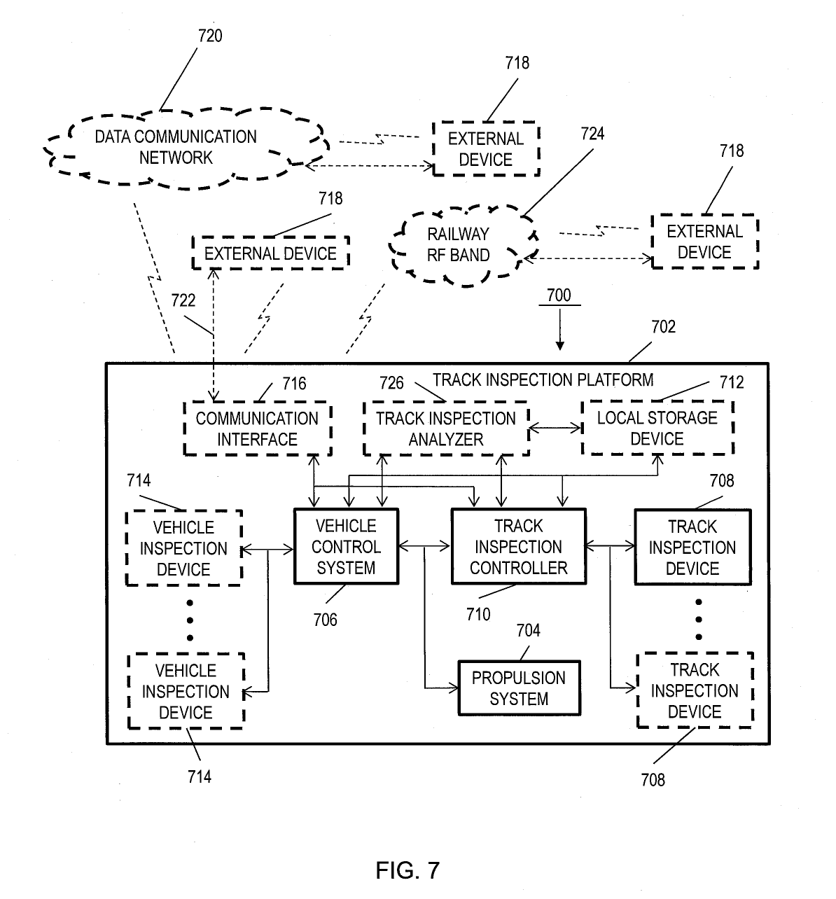

With reference to FIG. 7, an exemplary embodiment of a track inspection vehicle 700 for inspecting track in a railroad includes a track inspection platform 702 with a propulsion system 704 and a vehicle control system 706. The track inspection platform 702 configured to be positioned on a railroad formed by at least two tracks. The propulsion system 704 and vehicle control system 706 configured to selectively and adjustably operate and control the track inspection platform 702 to traverse the railroad in a self-propelled manner.

The track inspection vehicle 700 also including at least one track inspection device 708 and a track inspection controller 710. Each track inspection device 708 disposed on the track inspection platform 702 and configured to produce electronic inspection data relating to at least one condition of the railroad in conjunction with operation of the track inspection platform 702 to perform a railroad inspection task. The track inspection controller 710 disposed on the track inspection platform 702 and in operative communication with the vehicle control system 706 and the at least one track inspection device 708. The track inspection controller 710 configured to control one or more track inspection device 708 to selectively or continuously produce the corresponding electronic inspection data in conjunction with performance of the railroad inspection task.

In another embodiment of the track inspection vehicle 700, the track inspection platform 702 is configured to perform the railroad inspection task without a person on board. In yet another embodiment of the track inspection vehicle 700, the vehicle control system 706 is configured to process at least a portion of the electronic inspection data and to adjust control of the track inspection platform 702 based at least in part on the corresponding electronic inspection data. In still another embodiment of the track inspection vehicle 700, the at least one track inspection device 708 includes a rail data sensor, a speed determiner, a video camera, a proximity sensor, a rail flaw detector, a laser profiling sensor, a LIM reaction rail height sensor, a temperature sensor, a GPS receiver, an ultrasonic sensor, a pulsed radar sensor, an RFID sensor, an IR sensor, a vertical gyro assembly, a rate gyro assembly, a gauge measurement assembly, a distance measurement assembly, an accelerometer assembly, an encoder, a magnetic tester, or any suitable sensing or data collection device in any suitable combination.

In still yet another embodiment of the track inspection vehicle 700, the condition of the railroad subject to inspection includes a track anomaly, an internal track defect, a void, a crack, a risk of cracking, a risk of buckling, a narrow gauge, a wide gauge, a variation in gauge, a transverse fissure, a compound fissure, a detail fracture, an engine burn fracture, a defective weld, a horizontal split head, a vertical split head, a split web, a piped rail, a head web separation, a bolt hole crack, a broken base, an ordinary break, a damaged rail, a rail end mismatch, a misalignment, a warp, a surface defect, a runoff defect, an excess elevation, a reverse elevation, a maximum allowable operating speed exceeded (Vmax), a harmonic oscillation condition, a rail corrugation defect, a foreign object obstruction, or any detectable hazardous or unsafe condition in any combination.

In another embodiment of the track inspection vehicle 700, the railroad inspection task includes a twice weekly inspection, a weekly inspection, a twice monthly inspection, a monthly inspection, a quarterly inspection, a three times annually inspection, a twice annually inspection, an annual inspection, a post-installation inspection, a pre-maintenance inspection, a post-maintenance inspection, a scout mission after a natural disaster, train derailment, or maintenance alert, and a scout mission for a train.

In yet another embodiment, the track inspection vehicle 700 also includes a local storage device 712 disposed on the track inspection platform 702 and in operative communication with at least one of the vehicle control system 706 and the track inspection controller 710. In a further embodiment, the track inspection controller 710 is configured to at least temporarily store the electronic inspection data in the local storage device 712.

In still another embodiment of the track inspection vehicle 700, the vehicle control system 706 and track inspection controller 710 are configured to automatically perform the railroad inspection task without operator intervention, including traversing the railroad from an origination point to a destination point and selectively producing electronic inspection data from one or more track inspection device 708 during the traversing. In a further embodiment, at least one of the railroad inspection task, origination point, one or more interim point, destination point, direction of travel between points, speed between points, and location points for producing electronic inspection data from the one or more track inspection device 708 are programmable prior to starting the railroad inspection task. In an even further embodiment, at least one of the vehicle control system 706 and track inspection controller 710 are configured to permit operator intervention during the railroad inspection task such that at least one of the railroad inspection task, one or more interim point, destination point, direction of travel between points, speed between points, and location points for producing electronic inspection data from one or more track inspection device 708 are re-programmable after starting the railroad inspection task.

In still yet another embodiment, the track inspection vehicle 700 also includes at least one vehicle inspection device 714. Each vehicle inspection device 714 disposed on the track inspection platform and configured to produce electronic vehicle data relating to at least one vehicle condition in conjunction with operation of the track inspection platform 702. In a further embodiment, the at least one vehicle inspection device 714 includes one or more proximity sensor configured to detect a foreign object obstruction on the railroad. In this embodiment, the vehicle control system 706 is configured to process the electronic inspection data produced by the one or more proximity sensor to detect the foreign object obstruction on the railroad and to bring the track inspection platform 702 to a controlled stop to avoid a collision with the foreign object obstruction. In another further embodiment, the vehicle control system 706 is configured to process at least a portion of the electronic vehicle data and to adjust control of the track inspection platform 702 based at least in part on the corresponding electronic vehicle data. In yet another further embodiment, the at least one vehicle inspection device 714 includes a speed determiner, a video camera, a proximity sensor, a GPS receiver, an ultrasonic sensor, a pulsed radar sensor, an RFID sensor, an IR sensor, a vertical gyro assembly, a rate gyro assembly, a distance measurement assembly, an accelerometer assembly, an encoder, or any suitable sensing or data collection device in any suitable combination.

In another embodiment, the track inspection vehicle 700 also includes a communication interface 716 disposed on the track inspection platform 702 in operative communication with at least one of the vehicle control system 706 and the track inspection controller 710. The communication interface 716 configured to permit communication with an external device 718. In a further embodiment, the communication interface 716 is configured to permit data communication directly with the external device 718. In this embodiment, the communication interface 716 includes a short range wireless transceiver, a Bluetooth transceiver, an RF transceiver, an IR transceiver, an RFID transceiver, a LAN wireless transceiver, a WiFi transceiver, a multi-mode wireless transceiver, or any suitable transceiver in any suitable combination.

In another further embodiment, the communication interface 716 is configured to permit data communication with the external device 718 via a data communication network 720. In this embodiment, the communication interface 716 includes a wireless LAN transceiver, a WiFi transceiver, a WLAN transceiver, a wireless WAN transceiver, a WiMAX transceiver, a mobile network transceiver, a satellite network transceiver, a wireless multi-mode transceiver, or any suitable wireless transceiver in any suitable combination. In yet another further embodiment, the communication interface 716 is configured to permit data communication directly with the external device 718. In this embodiment, the communication interface is configured to be connected to the external device via a communication cable 722.

In still another further embodiment, at least one of the vehicle control system 706 and the track inspection controller 710 are configured to permit the external device 718 to access at least a portion of the electronic inspection data via the communication interface 716. In an even further embodiment, the at least one track inspection device 708 includes one or more video camera. In this embodiment, the external device 718 is permitted to access at least a portion of the electronic inspection data produced by the one or more video camera to identify a potential hazardous condition associated with the railroad and to capture at least one electronic image associated with the potential hazardous condition. In the embodiment being described, the communication interface 716 is configured to permit the external device 718 to send a potential defect trigger with the potential hazardous condition and the at least one electronic image associated therewith to at least one of the vehicle control system 706 and the track inspection controller 710.

In still yet another further embodiment, at least one of the vehicle control system 706 and the track inspection controller 710 are configured to send at least a portion of the electronic inspection data to the external device 718 via the communication interface 716. In another further embodiment, the external device 718 includes a laptop computer, a desktop computer, a tablet computer, a hand-held computer, a smart phone, a mobile phone, a satellite phone, a landline phone, a remote control unit, a programming device, or any suitable computing device in any suitable combination.

In yet another further embodiment, the communication interface 716 is configured to permit audio communication with the external device 718 via a railway RF band 724. In this embodiment, the communication interface 716 includes a railway radio. In an even further embodiment, at least one of the vehicle control system 706 and the track inspection controller 710 are configured to select or generate an audio message and send the audio message for broadcast over the railway RF band 724 via the communication interface 716. In another even further embodiment, at least one of the vehicle control system 706 and the track inspection controller 710 are configured to receive an audio message broadcast over the railway RF band 724 via the communication interface 716 and recognize at least one of audible tones and speech carried by the audio message.

In yet another embodiment, the track inspection vehicle 700 also includes an inspection data analyzer 726 and a local storage device 712. The inspection data analyzer 726 disposed on the track inspection platform 702 and in operative communication with the track inspection controller 710 and the vehicle control system 706. The inspection data analyzer 726 configured to process the electronic inspection data produced by one or more track inspection device 708 to form track measurements. The local storage device 712 disposed on the track inspection platform 702 and in operative communication with the inspection data analyzer 726 and at least one of the vehicle control system 706 and the track inspection controller 710. In this embodiment, the inspection data analyzer 726 is configured to at least temporarily store the track measurements in the local storage device 712.

In a further embodiment, the vehicle control system 706 is configured to process at least a portion of the track measurements and to adjust control of the track inspection platform 702 based at least in part on the corresponding track measurements. In another further embodiment, at least one of the inspection data analyzer 726 and track inspection controller 710 are configured to link the track measurements to time identifiers, location identifiers, and curvature component identifiers.

In yet another further embodiment, the at least one track inspection device 708 includes one or more video camera. In this embodiment, the inspection data analyzer 726 is configured to process the electronic inspection data produced by the one or more video camera to identify a potential hazardous condition associated with the railroad and to capture at least one electronic image associated with the potential hazardous condition. In the embodiment being described, the inspection data analyzer 726 is configured to at least temporarily store the potential hazardous condition and the at least one electronic image associated therewith in the local storage device 712.

In an even further embodiment, the vehicle control system 706 is configured to process at least one of at least a portion of the electronic inspection data associated with the potential hazardous condition and one or more electronic image associated with the potential hazardous condition and to adjust control of the track inspection platform 702 based at least in part on the corresponding electronic inspection data or electronic image. In another even further embodiment, at least one of the inspection data analyzer 726 and track inspection controller 710 are configured to link the potential hazardous condition and the at least one electronic image associated therewith to time identifiers, location identifiers, and curvature component identifiers.

In still another further embodiment, the inspection data analyzer 726 is configured to compare the track measurements to previously established thresholds to identify potential defects in the track. In this embodiment, the inspection data analyzer 726 is configured to at least temporarily store the potential defects in the local storage device 712.

In an even further embodiment, the inspection data analyzer 726 is configured to classify the potential defects between a degraded condition, a recommended maintenance condition, a priority alert condition, and an urgent alert condition. In this embodiment, the inspection data analyzer 726 is configured to at least temporarily store the classifications for the potential defects in the local storage device 712. In an even yet further embodiment, the inspection data analyzer 726 is configured to send a priority alert trigger to at least one of the vehicle control system 706 and the track inspection controller 710 in response to classifying a potential defect as a priority alert condition. In this embodiment, the inspection data analyzer 726 is configured to send an urgent alert trigger to at least one of the vehicle control system 706 and the track inspection controller 710 in response to classifying a potential defect as an urgent alert condition. In an even still further embodiment, the track inspection vehicle 700 also includes a communication interface 716 disposed on the track inspection platform 702 in operative communication with at least one of the vehicle control system 706 and the track inspection controller 710. In this embodiment, at least one of the vehicle control system 706 and the track inspection controller 710 are configured to select or generate an alert message in response to receiving a priority or urgent alert trigger and send the alert message to an external device 718 via the communication interface 716. In the embodiment being described, the alert message is selected or generated based at least in part on the corresponding potential defect and the corresponding priority or urgent alert condition.

In another even further embodiment, the inspection data analyzer 726 is configured to perform statistical analysis of the corresponding electronic inspection data for at least some types of potential defects to determine a probability associated with identification of the corresponding potential defect and a confidence level for the corresponding probability. In this embodiment, the inspection data analyzer 726 is configured to at least temporarily store the probability and confidence level for the potential defects in the local storage device 712. In an even yet further embodiment, the inspection data analyzer 726 is configured to send a repeat inspection trigger to the vehicle control system 706 and the track inspection controller 710 to return the track inspection platform 702 to a proximate location on the railroad associated with at least some types of potential defects if the confidence level for the probability associated therewith is below a predetermined confidence threshold. In this embodiment, the vehicle control system 706 is configured to control the track inspection platform 702 to return to a select point on the railroad associated with the proximate location in response to receiving the repeat inspection trigger and to traverse through the proximate location one or more times. In the embodiment being described, the track inspection controller 710 is configured to control the at least one track inspection device 708 to selectively or continuously produce additional electronic inspection data while the track inspection platform 702 traverses through the proximate location in response to receiving the repeat inspection trigger.

In an even still further embodiment, the inspection data analyzer 726 is configured to process the additional electronic inspection data, update the corresponding track measurement based at least in part on the additional electronic inspection data, update the comparison to the corresponding threshold based at least in part on the additional electronic inspection data, and update the corresponding statistical analysis based at least in part on the additional electronic inspection data. In an even still yet further embodiment, the inspection data analyzer 726 is configured to send a stop repeat inspection notice to the vehicle control system 706 and the track inspection controller 710 after the confidence level for the probability associated with the corresponding potential defect is no longer below the predetermined confidence threshold. In this embodiment, the vehicle control system 706 is configured to control the track inspection platform 702 to continue the railroad inspection task in response to receiving the stop repeat inspection notice. In the embodiment being described, the track inspection controller 710 is configured to control the at least one track inspection device 708 to selectively or continuously produce electronic inspection data in conjunction with continuing the railroad inspection task in response to receiving the stop repeat inspection notice.

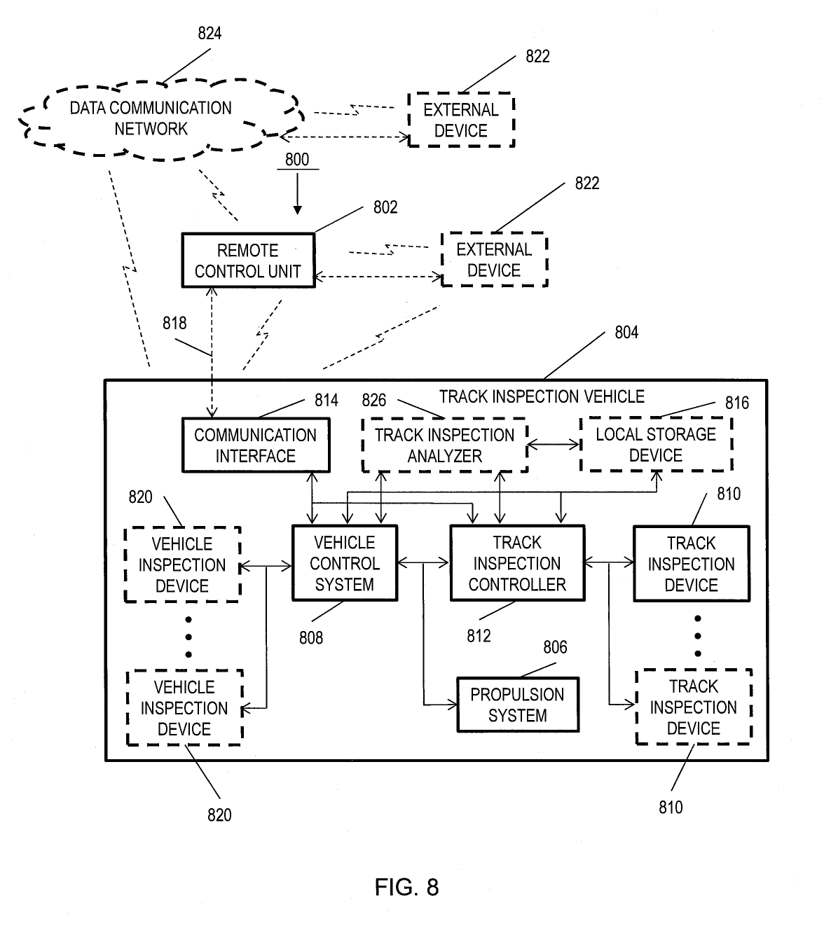

With reference to FIG. 8, an exemplary embodiment of a track inspection system 800 for inspecting track in a railroad includes a remote control unit 802 and a track inspection vehicle 804. The track inspection vehicle 804 in operative communication with the remote control unit 802. The track inspection vehicle 804 includes a track inspection platform configured to be positioned on a railroad formed by at least two tracks. The he track inspection platform including a propulsion system 806 and a vehicle control system 808. The propulsion system 806 and vehicle control system 808 are configured to selectively and adjustably operate and control the track inspection vehicle 804 to traverse the railroad in a self-propelled manner. The track inspection vehicle also includes at least one track inspection device 810, a track inspection controller 812, and a communication interface 814.

Each track inspection device 808 disposed on the track inspection platform and configured to produce electronic inspection data relating to at least one condition of the railroad in conjunction with operation of the track inspection vehicle 804 to perform a railroad inspection task. The track inspection controller 812 disposed on the track inspection platform and in operative communication with the vehicle control system 808 and the at least one track inspection device 810. The track inspection controller 812 configured to control one or more track inspection device 810 to selectively or continuously produce the corresponding electronic inspection data in conjunction with performance of the railroad inspection task.

The communication interface 814 disposed on the track inspection platform in operative communication with at least one of the vehicle control system 808 and the track inspection controller 812. The communication interface 814 configured to permit communication with the remote control unit 802. The remote control unit 802 is configured to operate and control the track inspection vehicle 804 for at least a portion of the railroad inspection task based at least in part on control signals exchanged with the track inspection vehicle 804 via the vehicle communication interface 814. At least one of the vehicle control system 808 and the track inspection controller 812 are configured to operate in response to the control signals exchanged with the remote control unit 802 for at least a portion of the railroad inspection task.

In another embodiment of the track inspection system 800, the track inspection vehicle 804 is configured to perform the railroad inspection task without a person on board. In yet another embodiment of the track inspection system 800, the track inspection platform is configured to allow a person to stand or sit on board for at least a portion of the railroad inspection task such that the person can operate the track inspection vehicle using the remote control unit 802 from onboard the track inspection vehicle 804. In still another embodiment of the track inspection system 800, the vehicle control system 808 is configured to process at least a portion of the electronic inspection data and to adjust control of the track inspection vehicle 804 based at least in part on the corresponding electronic inspection data.

In still yet another embodiment of the track inspection system 800, the track inspection vehicle 804 also includes a local storage device 816 disposed on the track inspection platform and in operative communication with at least one of the vehicle control system 808 and the track inspection controller 812. In this embodiment, the track inspection controller 812 is configured to at least temporarily store the electronic inspection data in the local storage device 816.

In another embodiment of the track inspection system 800, the remote control unit 802 includes a short range wireless transceiver, a Bluetooth transceiver, an RF transceiver, an IR transceiver, an RFID transceiver, a LAN wireless transceiver, a WiFi transceiver, a multi-mode wireless transceiver, or any suitable wireless transceiver in any suitable combination for data communication directly with the track inspection vehicle 804. In yet another embodiment of the track inspection system 800, the remote control unit 802 is configured to be connected to the track inspection vehicle 804 via a communication cable 818.

In still another embodiment of the track inspection system 800, the track inspection vehicle 804 is configured to autonomously perform the railroad inspection task without operator intervention after an initial setup and start activation with at least some interaction with the remote control unit 802. In this embodiment, the autonomous operation includes traversing the railroad from an origination point to a destination point and selectively producing electronic inspection data from one or more track inspection device 810 during the traversing. In a further embodiment, at least one of the railroad inspection task, origination point, one or more interim point, destination point, direction of travel between points, speed between points, and location points for producing electronic inspection data from the one or more track inspection device are programmable via interaction with the remote control unit 802 prior to starting the railroad inspection task. In an even further embodiment, at least one of the vehicle control system 808 and track inspection controller 812 are configured to permit operator intervention via interaction with the remote control unit 802 during the railroad inspection task such that at least one of the railroad inspection task, one or more interim point, destination point, direction of travel between points, speed between points, and location points for producing electronic inspection data from one or more track inspection device 810 are re-programmable after starting the railroad inspection task by the operator using the remote control unit 802.

In still yet another embodiment of the track inspection system 800, the track inspection vehicle 804 also includes at least one vehicle inspection device 820. Each vehicle inspection device 820 disposed on the track inspection platform and configured to produce electronic vehicle data relating to at least one vehicle condition in conjunction with operation of the track inspection vehicle 804. In a further embodiment, the at least one vehicle inspection device 820 includes one or more proximity sensor configured to detect a foreign object obstruction on the railroad. In this embodiment, the vehicle control system 808 is configured to process the electronic inspection data produced by the one or more proximity sensor to detect the foreign object obstruction on the railroad and to bring the track inspection vehicle 804 to a controlled stop to avoid a collision with the foreign object obstruction. In another further embodiment, the vehicle control system 808 is configured to process at least a portion of the electronic vehicle data and to adjust control of the track inspection vehicle 804 based at least in part on the corresponding electronic vehicle data.

In another embodiment of the track inspection system 800, the communication interface 814 is configured to permit communication with an external device 822.

In yet another embodiment of the track inspection system 800, the remote control unit 802 is configured to permit communication with an external device 822. In a further embodiment, the remote control unit 802 is configured to permit data communication directly with the external device 822. In this embodiment, the remote control unit 802 includes a short range wireless transceiver, a Bluetooth transceiver, an RF transceiver, an IR transceiver, an RFID transceiver, a LAN wireless transceiver, a WiFi transceiver, a multi-mode wireless transceiver, or any suitable wireless transceiver in any suitable combination for data communication directly with the external device 822. In another further embodiment, the remote control unit 802 is configured to permit data communication with the external device 822 via a data communication network 824. In this embodiment, the remote control unit 802 includes a wireless LAN transceiver, a WiFi transceiver, a WLAN transceiver, a wireless WAN transceiver, a WiMAX transceiver, a mobile network transceiver, a satellite network transceiver, a wireless multi-mode transceiver, or any suitable wireless transceiver in any suitable combination.

In yet another further embodiment, at least one of the vehicle control system 808 and the track inspection controller 812 are configured to permit the external device 822 to access at least a portion of the electronic inspection data via the remote control unit 802 through the communication interface 814. In an even further embodiment, the at least one track inspection device 810 includes one or more video camera. In this embodiment, the external device 822 is permitted to access at least a portion of the electronic inspection data produced by the one or more video camera to identify a potential hazardous condition associated with the railroad and to capture at least one electronic image associated with the potential hazardous condition. In the embodiment being described, the remote control unit 802 and communication interface 814 are configured to permit the external device 822 to send a potential defect trigger with the potential hazardous condition and the at least one electronic image associated therewith to at least one of the vehicle control system 808 and the track inspection controller 812.

In still another further embodiment, at least one of the vehicle control system 808 and the track inspection controller 812 are configured to send at least a portion of the electronic inspection data to the external device 822 via the remote control unit 802 through the communication interface 814. In still yet another further embodiment, the external device 822 includes at least one of a laptop computer, a desktop computer, a tablet computer, a hand-held computer, a smart phone, a mobile phone, a satellite phone, a landline phone, a programming device, and a computing device.

In still another embodiment of the track inspection system 800, the track inspection vehicle 804 also includes an inspection data analyzer 826 and a local storage device 816. The inspection data analyzer 826 disposed on the track inspection platform and in operative communication with the track inspection controller 812 and the vehicle control system 808. The inspection data analyzer 826 is configured to process the electronic inspection data produced by one or more track inspection device 810 to form track measurements. The local storage device 816 disposed on the track inspection platform and in operative communication with the inspection data analyzer 826 and at least one of the vehicle control system 808 and the track inspection controller 812. The inspection data analyzer 826 is configured to at least temporarily store the track measurements in the local storage device 816. In a further embodiment, the vehicle control system 808 is configured to process at least a portion of the track measurements and to adjust control of the track inspection vehicle 804 based at least in part on the corresponding track measurements. In another further embodiment, at least one of the inspection data analyzer 826 and track inspection controller 812 are configured to link the track measurements to time identifiers, location identifiers, and curvature component identifiers.

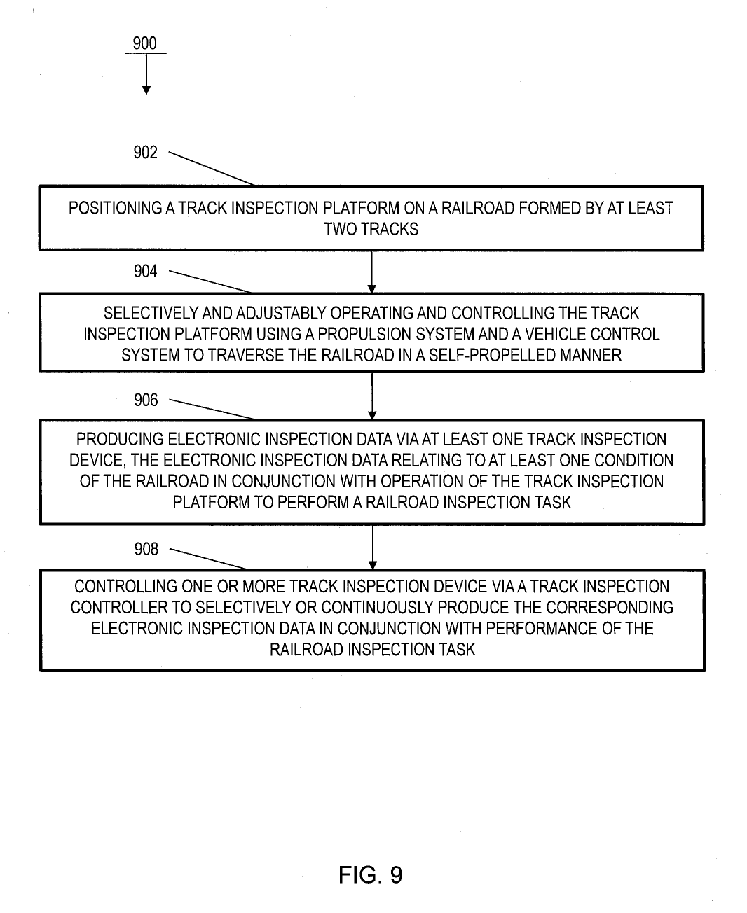

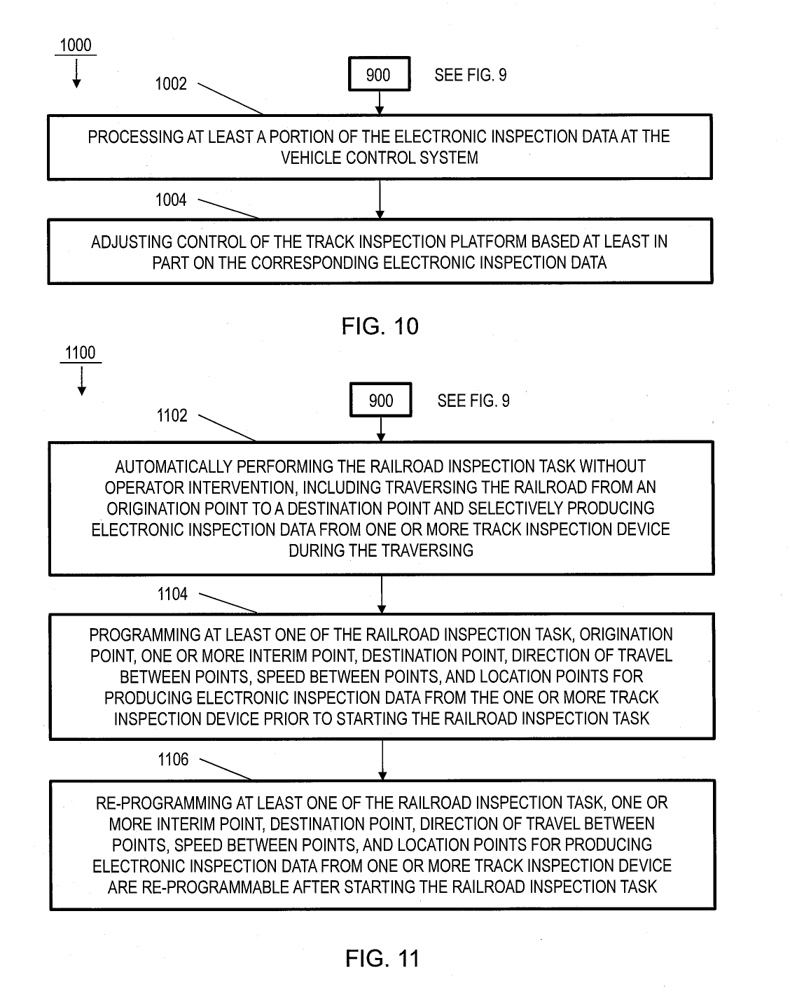

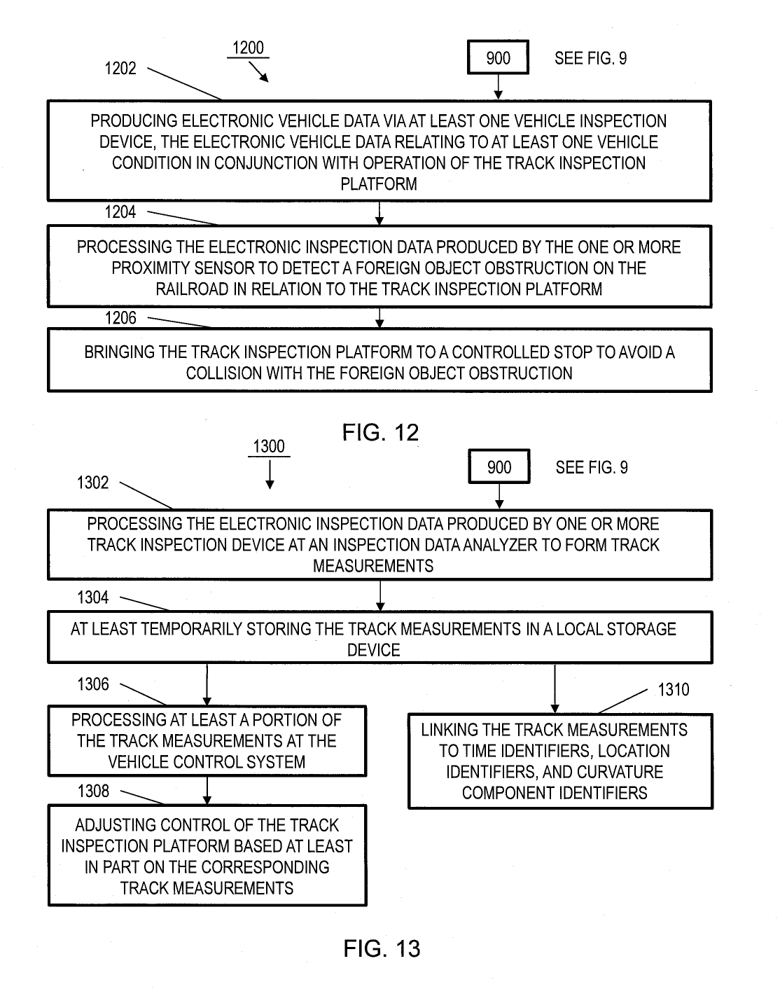

With reference to FIG. 9, an exemplary process 900 for inspecting track in a railroad begins at 902 where a track inspection platform is positioned on a railroad formed by at least two tracks. At 904, the track inspection platform is selectively and adjustably operated and controlled using a propulsion system and a vehicle control system to traverse the railroad in a self-propelled manner. Next, electronic inspection data is produced via at least one track inspection device (906). The electronic inspection data relating to at least one condition of the railroad in conjunction with operation of the track inspection platform to perform a railroad inspection task. At 908, one or more track inspection device is controlled via a track inspection controller to selectively or continuously produce the corresponding electronic inspection data in conjunction with performance of the railroad inspection task.

In another embodiment, the process 900 also includes performing the railroad inspection task without a person on board the track inspection platform.

In yet another embodiment, the process 900 also includes at least temporarily storing the electronic inspection data in a local storage device.

In still another embodiment, the process 900 also includes permitting communication between at least one of the vehicle control system and the track inspection controller with an external device via a communication interface associated with the track inspection platform. In a further embodiment, the process 900 also includes permitting data communication via the communication interface directly with the external device. In another further embodiment, the process 900 also includes permitting data communication through the communication interface with the external device via a data communication network. In yet another further embodiment, the process 900 also includes permitting data communication through the communication interface directly with the external device via a communication cable.

In still another further embodiment, the process 900 also includes permitting the external device to access at least a portion of the electronic inspection data via the communication interface. In an even further embodiment of the process 900, the at least one track inspection device includes one or more video camera. In this embodiment, the process 900 also includes permitting the external device to access at least a portion of the electronic inspection data produced by the one or more video camera to identify a potential hazardous condition associated with the railroad and to capture at least one electronic image associated with the potential hazardous condition. In them embodiment being described, the process 900 also includes permitting the external device to send a potential defect trigger with the potential hazardous condition and the at least one electronic image associated therewith to at least one of the vehicle control system and the track inspection controller via the communication interface.

In still yet another further embodiment, the process 900 also includes sending at least a portion of the electronic inspection data to the external device via the communication interface.

In another further embodiment, the process 900 also includes permitting audio communication through the communication interface with the external device via a railway RF band. In an even further embodiment, the process 900 also includes selecting or generating an audio message at the vehicle control system or track inspection controller. In this embodiment, the process 900 also includes sending the audio message for broadcast over the railway RF band via the communication interface. In another even further embodiment, the process 900 also includes receiving an audio message broadcast over the railway RF band at the vehicle control system or track inspection controller via the communication interface. In this embodiment, the process 900 also includes recognizing at least one of audible tones or speech carried by the audio message.

With reference to FIGS. 9 and 10, another exemplary embodiment of a process 1000 for inspecting track in a railroad includes process 900 (FIG. 9) and continues with processing at least a portion of the electronic inspection data at the vehicle control system (1002). At 1004, control of the track inspection platform is adjusted based at least in part on the corresponding electronic inspection data.

With reference to FIGS. 9 and 11, yet another exemplary embodiment of a process 1100 for inspecting track in a railroad includes process 900 (FIG. 9) and continues with automatically performing the railroad inspection task without operator intervention, including traversing the railroad from an origination point to a destination point and selectively producing electronic inspection data from one or more track inspection device during the traversing (1102). In a further embodiment, the process 1100 may also include programming at least one of the railroad inspection task, origination point, one or more interim point, destination point, direction of travel between points, speed between points, and location points for producing electronic inspection data from the one or more track inspection device prior to starting the railroad inspection task (1104). In an even further embodiment, the process 1100 may also include re-programming at least one of the railroad inspection task, one or more interim point, destination point, direction of travel between points, speed between points, and location points for producing electronic inspection data from one or more track inspection device are re-programmable after starting the railroad inspection task (1106).

With reference to FIGS. 9 and 12, still another exemplary embodiment of a process 1200 for inspecting track in a railroad includes process 900 (FIG. 9) and continues with producing electronic vehicle data via at least one vehicle inspection device (1202). In this embodiment, the electronic vehicle data relates to at least one vehicle condition in conjunction with operation of the track inspection platform. In a further embodiment of the process 1200 the at least one vehicle inspection device includes one or more proximity sensor. In this embodiment, the process 1200 may also include processing the electronic inspection data produced by the one or more proximity sensor to detect a foreign object obstruction on the railroad in relation to the track inspection platform (1204). In the embodiment being described, the process 1200 may also include bringing the track inspection platform to a controlled stop to avoid a collision with the foreign object obstruction (1206). In another further embodiment, the process 1200 may also include processing at least a portion of the electronic vehicle data at the vehicle control system. In this embodiment, the process 1200 may also include adjusting control of the track inspection platform based at least in part on the corresponding electronic vehicle data.

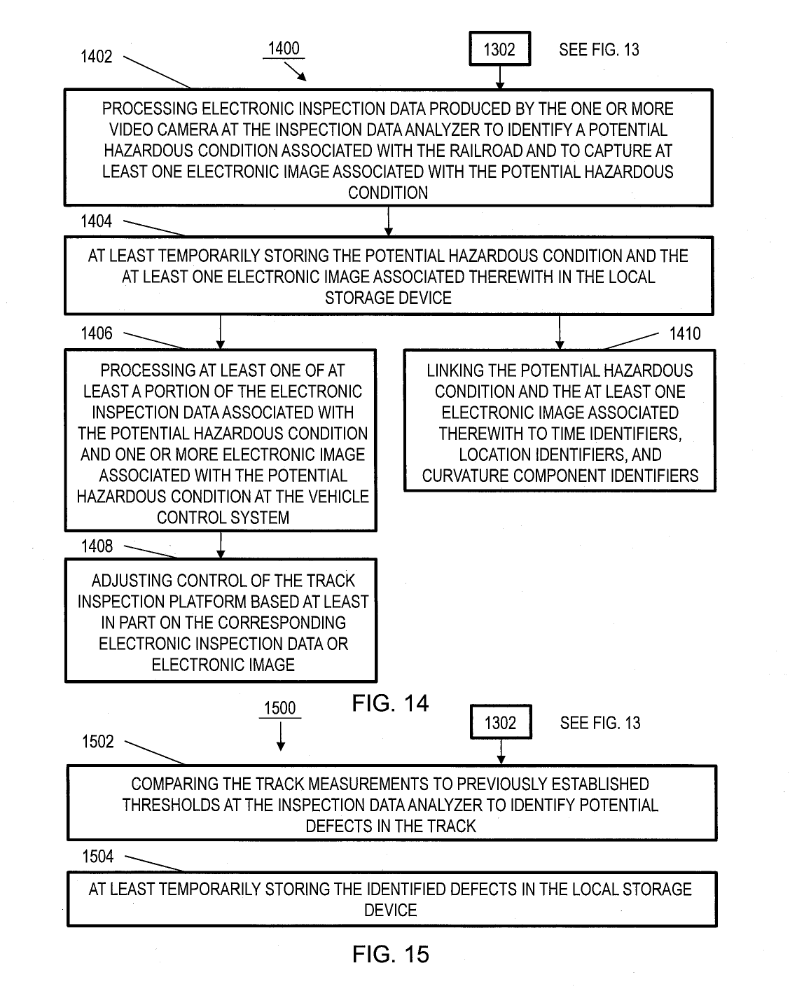

With reference to FIGS. 9 and 13, still yet another exemplary embodiment of a process 1300 for inspecting track in a railroad includes process 900 (FIG. 9) and continues with processing the electronic inspection data produced by one or more track inspection device at an inspection data analyzer to form track measurements (1302). At 1304, the track measurements are at least temporarily stored in a local storage device. In a further embodiment, the process 1300 may also include processing at least a portion of the track measurements at the vehicle control system (1306). In this embodiment, the process 1300 may also include adjusting control of the track inspection platform based at least in part on the corresponding track measurements (1308). In another further embodiment, the process 1300 may also include linking the track measurements to time identifiers, location identifiers, and curvature component identifiers (1310).

With reference to FIGS. 9, 13, and 14, another exemplary embodiment of a process 1400 for inspecting track in a railroad includes process 900 (FIG. 9) and 1302 of process 1300 (FIG. 13). In this embodiment, the at least one track inspection device includes one or more video camera. The process 1400 continues from 1302 with processing electronic inspection data produced by the one or more video camera at the inspection data analyzer to identify a potential hazardous condition associated with the railroad and to capture at least one electronic image associated with the potential hazardous condition (1402). At 1404, the potential hazardous condition and the at least one electronic image associated therewith are at least temporarily stored in the local storage device. In a further embodiment, the process 1400 also includes processing at least one of at least a portion of the electronic inspection data associated with the potential hazardous condition and one or more electronic image associated with the potential hazardous condition at the vehicle control system (1406). In this embodiment, the process 1400 also includes adjusting control of the track inspection platform based at least in part on the corresponding electronic inspection data or electronic image (1408). In another further embodiment, the process 1400 also includes linking the potential hazardous condition and the at least one electronic image associated therewith to time identifiers, location identifiers, and curvature component identifiers (1410).

With reference to FIGS. 9, 13, and 15, another exemplary embodiment of a process 1500 for inspecting track in a railroad includes process 900 (FIG. 9) and 1302 of process 1300 (FIG. 13). The process 1500 continues from 1302 with comparing the track measurements to previously established thresholds at the inspection data analyzer to identify potential defects in the track (1502). At 1504, the potential defects are at least temporarily stored in the local storage device.

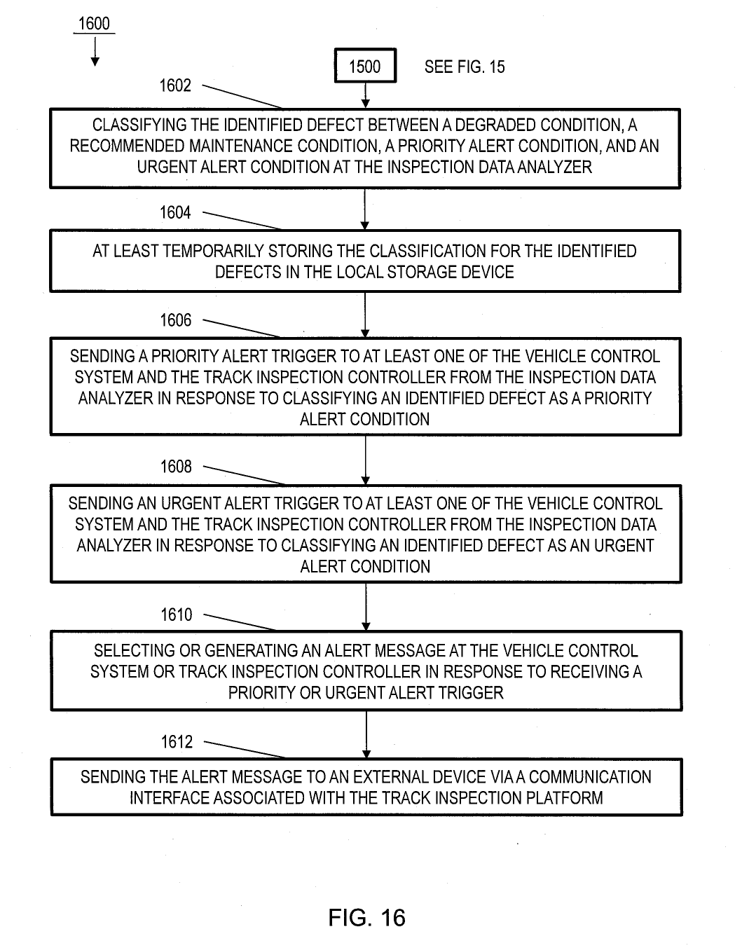

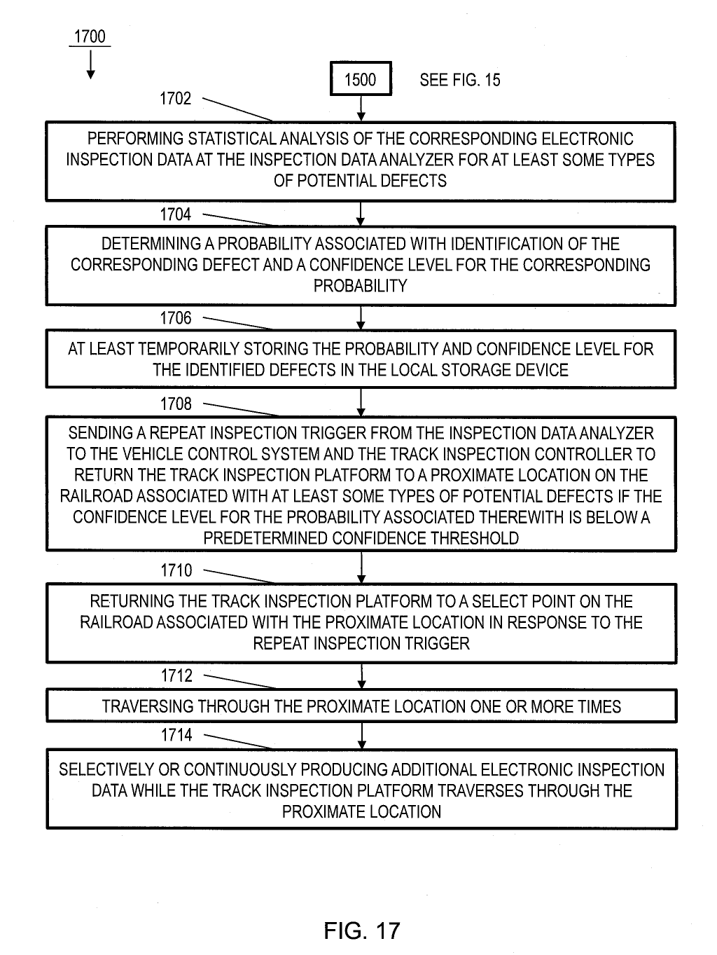

With reference to FIGS. 9, 13, 15, and 16, another exemplary embodiment of a process 1600 for inspecting track in a railroad includes process 900 (FIG. 9), 1302 of process 1300 (FIG. 13), and continues from process 1500 (FIG. 15) with classifying the potential defects between a degraded condition, a recommended maintenance condition, a priority alert condition, and an urgent alert condition at the inspection data analyzer (1602). At 1604, the classifications for the potential defects are at least temporarily stored in the local storage device (1604). In a further embodiment, the process 1600 also includes sending a priority alert trigger to at least one of the vehicle control system and the track inspection controller from the inspection data analyzer in response to classifying a potential defect as a priority alert condition (1606). In this embodiment, the process 1600 also includes sending an urgent alert trigger to at least one of the vehicle control system and the track inspection controller from the inspection data analyzer in response to classifying a potential defect as an urgent alert condition (1608). In an even further embodiment, the process 1600 also includes selecting or generating an alert message at the vehicle control system or track inspection controller in response to receiving a priority or urgent alert trigger (1610). In this embodiment, the process also includes sending the alert message to an external device via a communication interface associated with the track inspection platform (1612). In the embodiment being described, the alert message is selected or generated based at least in part on the corresponding potential defect and the corresponding priority or urgent alert condition.

With reference to FIGS. 9, 13, 15, and 17, another exemplary embodiment of a process 1700 for inspecting track in a railroad includes the process 900 (FIG. 9), 1302 of process 1300 (FIG. 13), and continues from process 1500 (FIG. 15) with performing statistical analysis of the corresponding electronic inspection data at the inspection data analyzer for at least some types of potential defects (1702). At 1704, a probability associated with identification of the corresponding potential defect is determined along with a confidence level for the corresponding probability. In this embodiment, the probabilities and confidence levels for the potential defects are at least temporarily stored in the local storage device (1706).

In a further embodiment, the process 1700 also includes sending a repeat inspection trigger from the inspection data analyzer to the vehicle control system and the track inspection controller to return the track inspection platform to a proximate location on the railroad associated with at least some types of potential defects if the confidence level for the probability associated therewith is below a predetermined confidence threshold (1708). At 1710, the track inspection platform returns to a select point on the railroad associated with the proximate location in response to the repeat inspection trigger. Next, the proximate location is traversed through one or more times (1712). At 1714, additional electronic inspection data is selectively or continuously produced while the track inspection platform traverses through the proximate location.

In an even further embodiment, the process 1700 also includes processing the additional electronic inspection data at the inspection data analyzer. In this embodiment, the process also includes updating the corresponding track measurement based on the additional electronic inspection data, updating the comparison to the corresponding threshold based on the additional electronic inspection data, and updating the corresponding statistical analysis based on the additional electronic inspection data.

In an even yet further embodiment, the process 1700 also includes sending a stop repeat inspection notice from the inspection data analyzer to the vehicle control system and the track inspection controller after the confidence level for the probability associated with the corresponding potential defect is no longer below the predetermined confidence threshold. In this embodiment, the process 1700 also includes controlling the track inspection platform to continue the railroad inspection task in response to receiving the stop repeat inspection notice. In the embodiment being described, the process 1700 also includes controlling the at least one track inspection device to selectively or continuously produce electronic inspection data in conjunction with continuing the railroad inspection task.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. An apparatus for inspecting track in a railroad, comprising:
a track inspection platform configured to be positioned on a railroad formed by at least two tracks, the track inspection platform including a propulsion system and a vehicle control system, wherein the propulsion system and vehicle control system are configured to selectively and adjustably operate and control the track inspection platform to traverse the railroad in a self-propelled manner;
at least one track inspection device, each track inspection device disposed on the track inspection platform and configured to produce electronic inspection data relating to at least one condition of the railroad in conjunction with operation of the track inspection platform to perform a railroad inspection task; and
a track inspection controller disposed on the track inspection platform and in operative communication with the vehicle control system and the at least one track inspection device, wherein the track inspection controller is configured to control one or more track inspection device to selectively or continuously produce the corresponding electronic inspection data in conjunction with performance of the railroad inspection task.

2. The apparatus of claim 1, further comprising:
a local storage device disposed on the track inspection platform and in operative communication with at least one of the vehicle control system and the track inspection controller;
wherein the track inspection controller is configured to at least temporarily store the electronic inspection data in the local storage device.

3. The apparatus of claim 1, further comprising:
at least one vehicle inspection device, each vehicle inspection device disposed on the track inspection platform and configured to produce electronic vehicle data relating to at least one vehicle condition in conjunction with operation of the track inspection platform;
wherein the at least one vehicle inspection device includes one or more proximity sensor configured to detect a foreign object obstruction on the railroad, wherein the vehicle control system is configured to process the electronic inspection data produced by the one or more proximity sensor to detect the foreign object obstruction on the railroad and to bring the track inspection platform to a controlled stop to avoid a collision with the foreign object obstruction.

4. The apparatus of claim 1, further comprising:
a communication interface disposed on the track inspection platform in operative communication with at least one of the vehicle control system and the track inspection controller, wherein the communication interface is configured to permit communication with an external device.

5. The apparatus of claim 4 wherein at least one of the vehicle control system and the track inspection controller are configured to permit the external device to access at least a portion of the electronic inspection data via the communication interface;
wherein the at least one track inspection device includes one or more video camera, wherein the external device is permitted to access at least a portion of the electronic inspection data produced by the one or more video camera to identify a potential hazardous condition associated with the railroad and to capture at least one electronic image associated with the potential hazardous condition;
wherein the communication interface is configured to permit the external device to send a potential defect trigger with the potential hazardous condition and the at least one electronic image associated therewith to at least one of the vehicle control system and the track inspection controller.

6. The apparatus of claim 4 wherein the communication interface is configured to permit audio communication with the external device via a railway RF band, wherein the communication interface includes a railway radio.

7. The apparatus of claim 1, further comprising:
an inspection data analyzer disposed on the track inspection platform and in operative communication with the track inspection controller and the vehicle control system, wherein the inspection data analyzer is configured to process the electronic inspection data produced by one or more track inspection device to form track measurements; and
a local storage device disposed on the track inspection platform and in operative communication with the inspection data analyzer and at least one of the vehicle control system and the track inspection controller;
wherein the inspection data analyzer is configured to at least temporarily store the track measurements in the local storage device.

8. The apparatus of claim 7 wherein the at least one track inspection device includes one or more video camera, wherein the inspection data analyzer is configured to process the electronic inspection data produced by the one or more video camera to identify a potential hazardous condition associated with the railroad and to capture at least one electronic image associated with the potential hazardous condition;
wherein the inspection data analyzer is configured to at least temporarily store the potential hazardous condition and the at least one electronic image associated therewith in the local storage device.

9. The apparatus of claim 7 wherein the inspection data analyzer is configured to compare the track measurements to previously established thresholds to identify potential defects in the track;
wherein the inspection data analyzer is configured to at least temporarily store the potential defects in the local storage device;
wherein the inspection data analyzer is configured to classify the potential defects between a degraded condition, a recommended maintenance condition, a priority alert condition, and an urgent alert condition;
wherein the inspection data analyzer is configured to at least temporarily store the classifications for the potential defects in the local storage device;
wherein the inspection data analyzer is configured to send a priority alert trigger to at least one of the vehicle control system and the track inspection controller in response to classifying a potential defect as a priority alert condition, wherein the inspection data analyzer is configured to send an urgent alert trigger to at least one of the vehicle control system and the track inspection controller in response to classifying a potential defect as an urgent alert condition;
the apparatus further comprising:
a communication interface disposed on the track inspection platform in operative communication with at least one of the vehicle control system and the track inspection controller;
wherein at least one of the vehicle control system and the track inspection controller are configured to select or generate an alert message in response to receiving a priority or urgent alert trigger and send the alert message to an external device via the communication interface, wherein the alert message is selected or generated based at least in part on the corresponding potential defect and the corresponding priority or urgent alert condition.

10. An apparatus for inspecting track in a railroad, comprising:
a remote control unit; and
a track inspection vehicle in operative communication with the remote control unit, the track inspection vehicle comprising:
a track inspection platform configured to be positioned on a railroad formed by at least two tracks, the track inspection platform including a propulsion system and a vehicle control system, wherein the propulsion system and vehicle control system are configured to selectively and adjustably operate and control the track inspection vehicle to traverse the railroad in a self-propelled manner;
at least one track inspection device, each track inspection device disposed on the track inspection platform and configured to produce electronic inspection data relating to at least one condition of the railroad in conjunction with operation of the track inspection vehicle to perform a railroad inspection task;
a track inspection controller disposed on the track inspection platform and in operative communication with the vehicle control system and the at least one track inspection device, wherein the track inspection controller is configured to control one or more track inspection device to selectively or continuously produce the corresponding electronic inspection data in conjunction with performance of the railroad inspection task; and
a communication interface disposed on the track inspection platform in operative communication with at least one of the vehicle control system and the track inspection controller, wherein the communication interface is configured to permit communication with the remote control unit;
wherein the remote control unit is configured to operate and control the track inspection vehicle for at least a portion of the railroad inspection task based at least in part on control signals exchanged with the track inspection vehicle via the vehicle communication interface;
wherein at least one of the vehicle control system and the track inspection controller are configured to operate in response to the control signals exchanged with the remote control unit for at least a portion of the railroad inspection task.

11. The apparatus of claim 10 wherein the track inspection platform is configured to allow a person to stand or sit on board for at least a portion of the railroad inspection task such that the person can operate the track inspection vehicle using the remote control unit from onboard the track inspection vehicle.

12. The apparatus of claim 10 wherein the track inspection vehicle is configured to autonomously perform the railroad inspection task without operator intervention after an initial setup and start activation with at least some interaction with the remote control unit, the autonomous operation including traversing the railroad from an origination point to a destination point and selectively producing electronic inspection data from one or more track inspection device during the traversing.

13. The apparatus of claim 10 wherein the remote control unit is configured to permit communication with an external device;
wherein at least one of the vehicle control system and the track inspection controller are configured to permit the external device to access at least a portion of the electronic inspection data via the remote control unit through the communication interface;
wherein the at least one track inspection device includes one or more video camera, wherein the external device is permitted to access at least a portion of the electronic inspection data produced by the one or more video camera to identify a potential hazardous condition associated with the railroad and to capture at least one electronic image associated with the potential hazardous condition;
wherein the remote control unit and communication interface are configured to permit the external device to send a potential defect trigger with the potential hazardous condition and the at least one electronic image associated therewith to at least one of the vehicle control system and the track inspection controller.

14. The apparatus of claim 10 wherein the remote control unit is configured to permit communication with an external device;
wherein at least one of the vehicle control system and the track inspection controller are configured to send at least a portion of the electronic inspection data to the external device via the remote control unit through the communication interface.

15. A method for inspecting track in a railroad, comprising:
positioning a track inspection platform on a railroad formed by at least two tracks;
selectively and adjustably operating and controlling the track inspection platform using a propulsion system and a vehicle control system to traverse the railroad in a self-propelled manner;
producing electronic inspection data via at least one track inspection device, the electronic inspection data relating to at least one condition of the railroad in conjunction with operation of the track inspection platform to perform a railroad inspection task; and
controlling one or more track inspection device via a track inspection controller to selectively or continuously produce the corresponding electronic inspection data in conjunction with performance of the railroad inspection task.

16. The method of claim 15, further comprising:
performing the railroad inspection task without a person on board the track inspection platform.

17. The method of claim 15, further comprising:
processing at least a portion of the electronic inspection data at the vehicle control system; and
adjusting control of the track inspection platform based at least in part on the corresponding electronic inspection data.

18. The method of claim 15, further comprising:
automatically performing the railroad inspection task without operator intervention, including traversing the railroad from an origination point to a destination point and selectively producing electronic inspection data from one or more track inspection device during the traversing;
programming at least one of the railroad inspection task, origination point, one or more interim point, destination point, direction of travel between points, speed between points, and location points for producing electronic inspection data from the one or more track inspection device prior to starting the railroad inspection task; and
re-programming at least one of the railroad inspection task, one or more interim point, destination point, direction of travel between points, speed between points, and location points for producing electronic inspection data from one or more track inspection device are re-programmable after starting the railroad inspection task.

19. The method of claim 15, further comprising:
producing electronic vehicle data via at least one vehicle inspection device, the electronic vehicle data relating to at least one vehicle condition in conjunction with operation of the track inspection platform;
wherein the at least one vehicle inspection device includes one or more proximity sensor, the method further comprising:
processing the electronic inspection data produced by the one or more proximity sensor to detect a foreign object obstruction on the railroad in relation to the track inspection platform; and
bringing the track inspection platform to a controlled stop to avoid a collision with the foreign object obstruction.

20. The method of claim 15, further comprising:
producing electronic vehicle data via at least one vehicle inspection device, the electronic vehicle data relating to at least one vehicle condition in conjunction with operation of the track inspection platform;
processing at least a portion of the electronic vehicle data at the vehicle control system; and
adjusting control of the track inspection platform based at least in part on the corresponding electronic vehicle data.

21. The method of claim 15, further comprising:
permitting communication between at least one of the vehicle control system and the track inspection controller with an external device via a communication interface associated with the track inspection platform; and
permitting the external device to access at least a portion of the electronic inspection data via the communication interface;
wherein the at least one track inspection device includes one or more video camera, the method further comprising:
permitting the external device to access at least a portion of the electronic inspection data produced by the one or more video camera to identify a potential hazardous condition associated with the railroad and to capture at least one electronic image associated with the potential hazardous condition; and
permitting the external device to send a potential defect trigger with the potential hazardous condition and the at least one electronic image associated therewith to at least one of the vehicle control system and the track inspection controller via the communication interface.

22. The method of claim 15, further comprising:
permitting communication between at least one of the vehicle control system and the track inspection controller with an external device via a communication interface associated with the track inspection platform; and
sending at least a portion of the electronic inspection data to the external device via the communication interface.

23. The method of claim 15, further comprising:
permitting communication between at least one of the vehicle control system and the track inspection controller with an external device via a communication interface associated with the track inspection platform;
permitting audio communication through the communication interface with the external device via a railway RF band;
selecting or generating an audio message at the vehicle control system or track inspection controller; and
sending the audio message for broadcast over the railway RF band via the communication interface.

24. The method of claim 15, further comprising:
permitting communication between at least one of the vehicle control system and the track inspection controller with an external device via a communication interface associated with the track inspection platform;
permitting audio communication through the communication interface with the external device via a railway RF band;
receiving an audio message broadcast over the railway RF band at the vehicle control system or track inspection controller via the communication interface; and
recognizing at least one of audible tones or speech carried by the audio message.

25. The method of claim 15, further comprising:
processing the electronic inspection data produced by one or more track inspection device at an inspection data analyzer to form track measurements; and
at least temporarily storing the track measurements in a local storage device.

26. The method of claim 25, further comprising:
processing at least a portion of the track measurements at the vehicle control system; and
adjusting control of the track inspection platform based at least in part on the corresponding track measurements.

27. The method of claim 25, further comprising:
linking the track measurements to time identifiers, location identifiers, and curvature component identifiers.

28. The method of claim 25 wherein the at least one track inspection device includes one or more video camera, the method further comprising:
processing electronic inspection data produced by the one or more video camera at the inspection data analyzer to identify a potential hazardous condition associated with the railroad and to capture at least one electronic image associated with the potential hazardous condition; and
at least temporarily storing the potential hazardous condition and the at least one electronic image associated therewith in the local storage device.

29. The method of claim 25, further comprising:
comparing the track measurements to previously established thresholds at the inspection data analyzer to identify potential defects in the track;
at least temporarily storing the potential defects in the local storage device;
classifying the potential defects between a degraded condition, a recommended maintenance condition, a priority alert condition, and an urgent alert condition at the inspection data analyzer;
at least temporarily storing the classifications for the potential defects in the local storage device;
sending a priority alert trigger to at least one of the vehicle control system and the track inspection controller from the inspection data analyzer in response to classifying a potential defect as a priority alert condition;
sending an urgent alert trigger to at least one of the vehicle control system and the track inspection controller from the inspection data analyzer in response to classifying a potential defect as an urgent alert condition;
selecting or generating an alert message at the vehicle control system or track inspection controller in response to receiving a priority or urgent alert trigger; and
sending the alert message to an external device via a communication interface associated with the track inspection platform;
wherein the alert message is selected or generated based at least in part on the corresponding potential defect and the corresponding priority or urgent alert condition.

30. The method of claim 25, further comprising:
comparing the track measurements to previously established thresholds at the inspection data analyzer to identify potential defects in the track;
at least temporarily storing the potential defects in the local storage device;
performing statistical analysis of the corresponding electronic inspection data at the inspection data analyzer for at least some types of potential defects;
determining a probability associated with identification of the corresponding potential defect and a confidence level for the corresponding probability;
at least temporarily storing the probabilities and confidence levels for the potential defects in the local storage device;
sending a repeat inspection trigger from the inspection data analyzer to the vehicle control system and the track inspection controller to return the track inspection platform to a proximate location on the railroad associated with at least some types of potential defects if the confidence level for the probability associated therewith is below a predetermined confidence threshold;
returning the track inspection platform to a select point on the railroad associated with the proximate location in response to the repeat inspection trigger;
traversing through the proximate location one or more times;
selectively or continuously producing additional electronic inspection data while the track inspection platform traverses through the proximate location;
processing the additional electronic inspection data at the inspection data analyzer;
updating the corresponding track measurement based on the additional electronic inspection data;
updating the comparison to the corresponding threshold based on the additional electronic inspection data;
updating the corresponding statistical analysis based on the additional electronic inspection data;
sending a stop repeat inspection notice from the inspection data analyzer to the vehicle control system and the track inspection controller after the confidence level for the probability associated with the corresponding potential defect is no longer below the predetermined confidence threshold;
controlling the track inspection platform to continue the railroad inspection task in response to receiving the stop repeat inspection notice; and
controlling the at least one track inspection device to selectively or continuously produce electronic inspection data in conjunction with continuing the railroad inspection task.
